(19) United States
(12) Patent Application Publication
(10) Pub. No.: US 2024/0315818 A1
(43) Pub. Date: Sep. 26, 2024

(54) NOZZLE FOR ORAL IRRIGATOR, AND ORAL IRRIGATOR

(71) Applicant: Guangzhou Stars Pulse Co., Ltd., Guangzhou (CN)

(72) Inventors: Huijia LIANG, Guangzhou (CN); Shihua LIU, Guangzhou (CN); Zhuoying LI, Guangzhou (CN); Kebi DING, Guangzhou (CN)

(21) Appl. No.: 18/736,450

(22) Filed: Jun. 6, 2024

Related U.S. Application Data
(63) Continuation-in-part of application No. PCT/CN2023/109395, filed on Jul. 26, 2023.

(30) Foreign Application Priority Data
Jul. 28, 2022 (CN) 202221979013.4
May 10, 2023 (CN) 202321132166.X
May 10, 2023 (CN) 202321133213.2
Jun. 20, 2023 (CN) 202321589808.9

(51) Int. Cl. A61C 17/02

(52) U.S. Cl. CPC A61C 17/02

(57) ABSTRACT

The present disclosure provides a nozzle for oral irrigator, comprising a spray head, the spray head comprising: a spray head main body, defining a first flow channel extending in an axial direction therein, one end of the first flow channel is formed as a water inlet, and the other end is formed as a water outlet; and a stopping structure, comprising two limiting portions and two locating portions, the first direction and the second direction are perpendicular to each other, and the two limiting portions respectively extend from the spray head main body in directions away from each other, such that a first free end of the two abutting members extending from the spray head main body is farther away from the axial direction of the spray head main body than a second free end of the two locating portions extending from the spray head main body.

### CROSS REFERENCE TO RELATED APPLICATIONS

This application claims the benefit of priority of Chinese patent application No. 202221979013.4, filed on Jul. 28, 2022, Chinese patent application No. 202321133213.2, filed on May. 10, 2023, Chinese patent application No. 202321132166.X, filed on May. 10, 2023, Chinese patent application No. 202321589808.9, filed on Jun. 20, 2023, the entire contents of which are incorporated herein by reference. This application is a continuation-in-part under 35 U.S.C. § 120 of international patent application PCT/CN2023/109395 filed Jul. 26, 2023.

### TECHNICAL FIELD

The present disclosure relates to a technical field of tooth cleaning, and in particular to a nozzle for oral irrigator and an oral irrigator.

### BACKGROUND

Due to presence of saliva in the oral cavity and smoothness of the tooth surface, when using an oral irrigator to clean the oral cavity, the nozzle of the oral irrigator is prone to slipping when in contact with the teeth, which affects the oral cleaning effect and cleaning efficiency, especially in cleaning the gaps between teeth; Moreover, if the oral irrigator is not operated properly, such as when a force is not applied properly, the nozzle may slide along the surface of the tooth to the gums or the insides of the oral cavity, causing damage to the gums or the insides of the oral cavity.

### BRIEF DESCRIPTION OF DRAWINGS

Implementations of the present technology will now be described, by way of example only, with reference to the attached figures.

FIG. 1 is an isometric view of a spray head according to an embodiment of the present disclosure.

FIG. 2 is another isometric diagram of the spray head shown in FIG. 1, in which the dashed line is a connecting line between free ends of two limiting portions.

FIG. 3 is yet another isometric view of the spray head shown in FIG. 1.

FIG. 4 is a cross-sectional view of the spray head shown in FIG. 1.

FIG. 5 is a isometric view of a spray head according to another embodiment of the present disclosure.

FIG. 6 is a perspective view showing a spray head according to yet another embodiment of the present disclosure.

FIG. 7 is a top view of the spray head shown in FIG. 6.

FIG. 8 is a cross-sectional view taken along line A-A of FIG. 7.

FIG. 9 is a isometric diagram of a usage state of a spray head according to an embodiment of the present disclosure.

FIG. 10 is a isometric diagram of another usage state of a spray head according to an embodiment of the present disclosure.

FIG. 11 is a perspective view showing a spray head according to a second embodiment of the present disclosure.

FIG. 12 is a top view of the spray head shown in FIG. 11.

FIG. 13 is a cross-sectional view taken along line B-B of FIG. 12.

FIG. 14 is a cross-sectional view of a nozzle according to an embodiment of the present disclosure.

FIG. 15 is a cross-sectional view of a nozzle according to another embodiment of the present disclosure.

FIG. 16 is a perspective view of a nozzle according to yet another embodiment of the present disclosure.

FIG. 17 is a cross-sectional view of the nozzle shown in FIG. 16.

FIG. 18 is a cross-sectional view of a deformation portion, a soft flange, a connecting sleeve, and an limiting portion of the nozzle shown in FIG. 16.

FIG. 19 is a perspective diagram of a usage state of the nozzle shown in FIG. 16.

FIG. 20 is a perspective diagram of another usage state of the nozzle shown in FIG. 16.

FIG. 21 is a perspective view of a nozzle according to yet another embodiment of the present disclosure.

FIG. 22 is a perspective view of a nozzle according to still another embodiment of the present disclosure.

FIG. 23 is a perspective diagram of the local cross-sectional structure taken along line A-A of FIG. 22.

FIG. 24 is a perspective diagram of the local cross-sectional structure taken along line A-A of FIG. 22.

FIG. 25 is an enlarged structural diagram at position B in FIG. 22.

FIG. 26 is a perspective diagram of a nozzle according to a further embodiment of the present disclosure.

FIG. 27 is a cross-sectional view of the nozzle shown in FIG. 26.

FIG. 28 is an enlarged view of portion A circled in FIG. 27.

### DETAILED DESCRIPTION

The following describes the embodiments of the present disclosure in detail, examples of which are illustrated in the drawings, where same or similar reference numerals are used to indicate same or similar members or members having same or similar functions. The embodiments described herein with reference to drawings are exemplary, is only used for explaining the present disclosure, and cannot be understood as a limitation to the present disclosure.

The following disclosure provides many different embodiments or examples for implementing different structures of the present disclosure. In order to simplify the disclosure of the present disclosure, components and settings of specific examples are described below. Surely, they are merely examples and are not intended to limit the application. In addition, reference numerals and/or letters may be repeated in different examples. This repetition is for the purpose of simplicity and clarity, and does not indicate a relationship between the various embodiments and/or arrangements discussed. Additionally, examples of various specific processes and materials are provided herein, but one of ordinary skill in the art may recognize applicability of other processes and/or use of other materials.

Hereinafter, a spray head 100 of a nozzle 200 according to an embodiment of the present disclosure will be described with reference to the drawings.

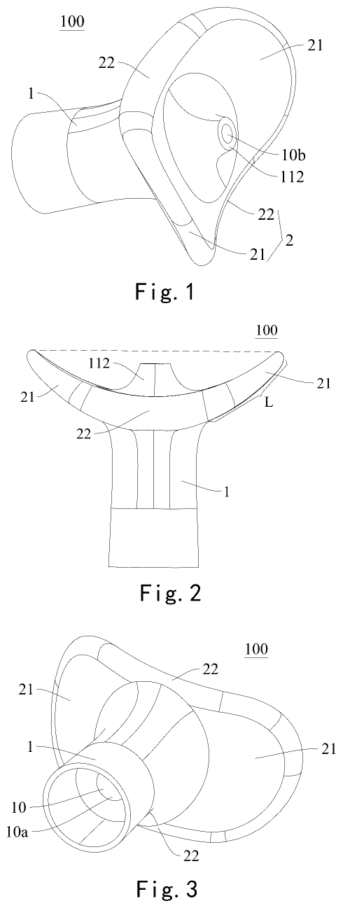

As shown in FIGS. 1-4, the spray head 100 comprises a spray head main body 1 and a stopping structure 2.

A first flow channel 10 is defined in the spray head main body 1, one end of the first flow channel 10 is formed as a water inlet 10a, and the other end is formed as a water outlet 10b. Water flow, such as cleaning solution, can flow into the first flow channel 10 via the water inlet 10a and be sprayed out via the water outlet 10b to facilitate the cleaning of the oral cavity.

The stopping structure 2 is disposed on an outer peripheral wall of the spray head main body 1, and comprises two limiting portions 21 arranged opposite to each other in the radial direction of the first flow channel 10, respectively extending in directions away from each other. In the radial direction of the first flow channel 10, the water outlet 10b is located between the free ends of the two limiting portions 21, so that the free ends of the two limiting portions 21 are located on both sides of the water outlet 10b in the radial direction of the first flow channel 10.

Wherein, the two limiting portions 21 are adapted to respectively abut against adjacent teeth belonging to the same row, and the two limiting portions 21 abut against different teeth, so that the water outlet 10b is adapted to be opposite to a slot of the adjacent teeth. That is, when using the spray head 100, if the spray head 100 is used to clean an upper row of teeth, one of the limiting portions 21 is adapted to abut against one of the two adjacent teeth of the upper row of teeth, the other limiting portion 21 is adapted to abut against the other of the two adjacent teeth, and the water outlet 10b is located between the free ends of the two limiting portions 21, so that the water outlet 10b is opposite to a tooth slit between the described two adjacent teeth(i.e. an upper tooth slit in the oral cavity), the tooth slit can be effectively cleaned by water jets from the water outlet 10b; If the spray head 100 is used for cleaning the lower row of teeth, one of the limiting portions 21 is adapted to abut against one of the two adjacent teeth of the lower row of teeth, the other limiting portion 21 is adapted to abut against the other of the two adjacent teeth, and the water outlet 10b is located between the free ends of the two limiting portions 21 to be opposite to a tooth slit between the described two adjacent teeth(i.e. an lower tooth slit in the oral cavity), the tooth slit can be effectively cleaned by water jets from the water outlet 10b.

It can be understood that when the spray head 100 is used, at least a free end portion of each of the limiting portions 21 is adapted to abut against teeth, and the spray head 100 can simultaneously abut against two adjacent teeth via the two limiting portions 21, such that the two adjacent teeth apply reverse supporting force to the spray head 100 respectively; Since the two limiting portions 21 respectively extend away from each other, the force applied to the spray head 100 by two adjacent teeth causes a tendency of the two abutments 21 to spread apart or expand, so that two adjacent teeth support the spray head 100 relative to each other, so as to effectively ensure that the spray head 100 is stably located at a certain position under the action of an external force applied by a user, an acting force applied by teeth etc., thus limiting the spray head 100 and preventing the spray head 100 from sliding relative to teeth, and further preventing the spray head 100 from damaging the gums or the inner wall of the oral cavity due to improper use etc. during cleaning, the operation convenience and safety performance of the spray head 100 are improved, thereby improving the user's experience. In addition, it can be ensured that the water outlet 10b is opposite to a slit between two adjacent teeth against which the two limiting portions 21 abut, thereby effectively cleaning the slit and ensuring cleaning effect and cleaning efficiency.

According to the spray head 100 of the nozzle 200 of the present disclosure, by providing a the stopping structure 2 on the outer peripheral wall of the spray head main body 1, the stopping structure 2 comprises two limiting portions 21 oppositely arranged in the radial direction of the first flow channel 10, and the two limiting portions 21 are adapted to respectively abut against two adjacent teeth belonging to the same row, so that the water outlet 10b is suitable to be opposite to a slit between adjacent teeth, thereby effectively cleaning the slit and ensuring cleaning effect and cleaning efficiency. Meanwhile, the force applied to the spray head 100 by two adjacent teeth causes a tendency of the two abutments 21 to spread apart or expand, so that two adjacent teeth support the spray head 100 relative to each other, thus limiting the spray head 100 and preventing the spray head 100 from damaging the gums or the inner wall of the oral cavity due to improper use etc. during cleaning, the operation convenience and safety performance of the spray head 100 are improved.

It should be understood that, for each limiting portion 21, the limiting portion 21 may extend linearly from the end connected with the spray head main body 1 towards the free end of the limiting portion 21, or the limiting portion 21 may extend in a curved manner (such as an arc, parabola, hyperbola, etc.) from the end connected with the spray head main body 1 towards the free end of the limiting portion 21.

In the spray head 100 of the embodiments of the present disclosure, both of the two limiting portions 21 extend linearly from the end thereof connected with the spray head main body 1 towards the free end thereof, so that the two limiting portions 21 can be substantially V-shaped; or both the two limiting portions 21 extend in a curved manner from the end thereof connected with the spray head main body 1 towards the free end thereof, in a curved manner, so that the two limiting portions 21 may be substantially U-shaped, etc.; or one of the two limiting portions 21 extends linearly from the end thereof connected with the spray head main body 1 towards the free end thereof, and the other one extends in a curved manner from the end connected with the spray head main body 1 towards the free end thereof.

Thus, two limiting portions 21 have a tendency of relative expansion when being subjected to an acting force applied by teeth, which is beneficial to enable the limiting portions 21 to contact more areas of tooth surfaces, and increase the contact area between the limiting portions 21 and teeth; Meanwhile, the abutment between the limiting portion 21 and the teeth is more stable, which facilitates improving the positioning stability of the water outlet 10b.

Optionally, the two limiting portions 21 of the spray head 100 extend from the end thereof connected to the spray head main body 1 toward the arc of the free end thereof, so as to ensure that the limiting portions 21 are subjected to uniform force, and situations such as crack generated by the limiting portions 21 cause by reaching the fatigue limit are effectively avoided, thereby improving the service life of the spray head 100.

In some embodiments of the present disclosure, the limiting portion 21 is made of a soft material, so that the limiting portion 21 can be deformed under the action of an external force, so as to increase the contact area between the limiting portion 21 and the teeth, so that the spray head 100 enhances the fitting effect between the limiting portion 21 and the teeth under the action of an external force, thus, the support stability of adjacent teeth on the spray head 100 is improved, and further ensuring that the spray head 100 is in contact with teeth and is not easy to slide relative to the teeth; In addition, due to the excellent deformation ability of the supporting part 21, it is convenient for the limiting portion 21 to be suitable for abutting against two adjacent teeth having different shapes and different arrangements, so that the spray head 100 can be suitable for different people and can also be suitable for arrangement shapes of different teeth of the same user, thereby improving the versatility of the spray head 100.

Therein, each limiting portion 21 bends towards the water outlet direction, and each limiting portion 21 extends in a curved manner from the end connected with the spray head main body 1 towards a direction away from the other limiting portion 21 and towards a direction near the water outlet 10b, so as to ensure that the limiting portions 21 are subjected to uniform force, and situations such as crack generated by the limiting portions 21 cause by reaching the fatigue limit are effectively avoided, thereby improving the service life of the spray head 100.

Therefore, when the limiting portion 21 has a certain deformation capability, the deformation of the limiting portion 21 enables the limiting portion 21 to adapt to the surface form of the teeth so as to fit the teeth, and the elastic restoring force generated by the deformation of the limiting portion 21 enables the limiting portion 21 to press against the tooth surface, which can prevent the splashing of the cleaning solution during tooth cleaning, so as to gather more water and rush towards the teeth slit, thereby improving the cleaning effect of the teeth slit; In addition, by means of the deformation of the limiting portion 21, the distance between the water outlet 10b and the teeth slit can be adjusted, so that the water outlet 10b is closer to the teeth slit, and the teeth slit can be centrally flushed, thereby improving the water impact effect.

Thus, under the dual action of gathering water by the limiting portion 21 fitting the tooth face with water and the water outlet 10b being close to the teeth slit so as to reduce splashing outside the teeth slit, the teeth rinsing effect is effectively improved.

Optionally, the limiting portion 21 is made of a soft rubber, so that the limiting portion 21 is soft and will not scratch the mouth, thereby further improving the user experience.

In some embodiments of the present disclosure, as shown in FIG. 1 to FIG. 4, in the radial direction of the first flow channel 10, the thickness of each of the limiting portions 21 gradually decreases in a direction away from the spray head main body 1, for each limiting portion 21, the end of the limiting portion 21 connected to the spray head main body 1 (i.e. the base of the limiting portion 21) has the largest thickness, and the thickness of the free end of the limiting portion 21 is the smallest, so that the structural strength of the base of the limiting portion 21 can be improved, to ensure the connection reliability between the limiting portion 21 and the spray head main body 1; Meanwhile, the stress deformation ability of the limiting portion 21 in the direction from the free end towards the end of the limiting portion 21 connected to the spray head main body 1 is gradually reduced, when the limiting portion 21 is subjected to a counterforce applied by the teeth, the deformation amplitude of the limiting portion 21 gradually decreases in the direction from the free end towards the end of the limiting portion 21 connected to the spray head main body 1, Thus, the support capability of the limiting portion 21 is improved, and it is suitable for the use requirements of different users; Furthermore, the limiting portion 21 is in contact with the teeth to gradually deform the limiting portion 21, so that the contact area between the surface of the limiting portion 21 and the tooth surface is gradually increased. However, during the application of force by the user, the resist deformation ability of the limiting portion 21 is gradually increased, which can effectively avoid the situation that the limiting portion 21 easily deforms and easily causes the water outlet 10b to contact with the tooth face to cause pore blockage, or cause the spray head main body 1 to be deformed.

In some embodiments, the thickness of the end of each limiting portion 21 connected with the spray head main body 1 is t1, and the thickness of the free end of each limiting portion 21 is t2.

For example, 0.5 mm≤t1≤3 mm, 0 mm<t2≤0.5 mm, which ensure that the limiting portion 21 is connected to the spray head main body 1 reliably, and the limiting portion 21 has a certain supporting capability; At the same time, the limiting portion 21 has a certain deformation capability, i. e. the limiting portion 21 has both the support capability and the deformation capability. For example, t1 is 0.5 mm, or 0.9 mm, or 1.6 mm, or 2 mm, or 2.4 mm, or 3 mm etc., t2 is 0.1 mm, or 0.2 mm, or 0.3 mm, or 0.4 mm, or 0.5 mm etc.

For example, 0<t2/t1≤0.8, it is also good for the abutment 21 to take both the supporting capacity and the deformation capacity into account. For example, t2/t1 is 0.1, or 0.2, or 0.5, or 0.8, etc.

For example, 0.5 mm≤t1≤3 mm, 0 mm<t2≤0.5 mm, [symbol] 0<t2/t1≤0.8, which is good for the abutment 21 to take both the supporting capacity and the deformation capacity into account. For example, when t1 is 0.5 mm, t2 is 0.2 mm, or 0.3 mm, or 0.4 mm, etc.; when t1 is 2 mm, t2 is 0.3 mm, or 0.4 mm, or 0.5 mm, etc.; and when t1 is 3 mm, t2 is 0.3 mm, or 0.4 mm, or 0.5 mm, etc.

It should be noted that, in the present disclosure, the meaning of “and/or” includes three parallel solutions. By taking “A and/or B” as an example, the solution includes solutions A or B, or both A and B.

In some embodiments of the present disclosure, as shown in FIG. 5, a groove 10c is formed on a peripheral wall of the first flow channel 10, the groove 10c extends spirally in an extending direction of the first flow channel 10, so that a part of water in the first flow channel 10 may flow spirally in the groove 10c, so that part of water sprayed from the water outlet 10b flows in a spiral manner, so as to improve the cleaning capability of the water flow at the water outlet 10b, in addition, it is convenient to enlarge the rinsing range of the water flow at the water outlet 10b, thereby improving the cleaning range.

It should be understood that there may be one or more grooves 10c, when there are a plurality of grooves 10c, the plurality of grooves 10c may be arranged at intervals along the circumference of the first flow channel 10. Otherwise, the spiral angles of the grooves 10c can be specifically set according to practical requirements; When there are a plurality of grooves 10c, the spiral angles of the plurality of grooves 10c can be the same or different.

In some embodiments of the present disclosure, as shown in FIG. 1 to FIG. 4, the stopping structure 2 further comprises two locating portions 22 arranged faced to each other in the radial direction of the first flow channel 10, two locating portions 22 are arranged opposite each other in a first direction, and the two locating portions 22 are respectively connected with the spray head main body 1, while extending from the connecting end 221 connected with the spray head main body 1 along the second direction to the free end 222, the two limiting portions 21 are arranged opposite each other in a second direction, and a plane formed by the first direction and the second direction is parallel to or overlap with a corresponding radial plane to the first flow channel 10, the first direction is perpendicular to the second direction.

The two locating portions 22 abut against the upper gums and the lower gums respectively, and one of the locating portions 22 abuts against the upper gums, the other locating portion 22 abuts against the lower gums. When the upper row of teeth is flushed, one of the locating portions 22 can abut against the upper gums for positioning purposes, and further ensure the stability and reliable limit of the spray head 100. In the radial direction of the first flow channel 10, the water outlet 10b is located between the two locating portions 22, so that the water outlet 10b is spaced apart from the upper edge of the spray head 100, and ensure that the water flowing out of the water outlet 10b can be sprayed to the upper teeth slit; When rinsing the lower row of teeth, the other locating portion 22 can abut against the lower gums to play a locating role. At this time, the water outlet 10b is spaced apart from the lower edge of the spray head 100, so as to ensure that the water flowing out of the water outlet 10b can be sprayed to the lower tooth slit.

Optionally, in the example of FIG. 1-5, the spray head main body 1 comprises a protruding portion 112, the protruding portion 112 is located at one end of the spray head main body 1, a water outlet 10b is defined at one end of the protruding portion 112, the stopping structure 2 comprises two limiting portions 21 and two locating portions 22, and the arrangement of the locating portions 22 can also play a blocking role, so as to prevent the protruding portion 112 from directly contacting teeth or gums and being pressed and deformed to cause a hole blockage, etc. Of course, the stopping structure 2 comprising two limiting portions 21 and two locating portions 22 may also be suitable for the case that the spray head main body 1 does not comprise the protruding portion 112.

In some embodiments, as shown in FIGS. 1-5, the stopping structure 2 is disposed to surround the spray head main body 1, the free ends 222 extended from the spray head main body 1 by the two limiting portions 21 are farther away from the axial direction x of the spray head main body 1 than the free ends 222 extended from the nozzle main body 1 by the two locating portions 22, the stopping structure 2 may be generally formed as an annular structure, the inner ring of the annular structure is connected to the spray head main body 1, and two locating portions 22 and two limiting portions 21 may be connected as a whole, so as to further improve deformation of the limiting portions 21 and the locating portions 22 during use of the spray head 100.

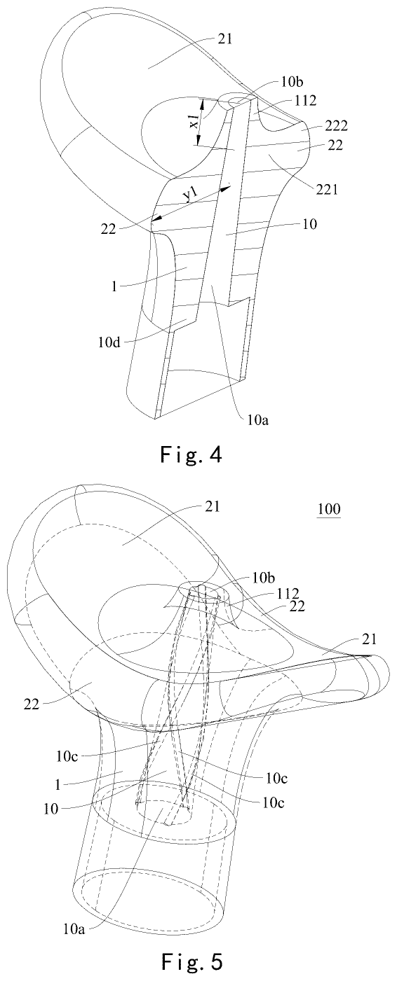

In some embodiments, as shown in FIG. 4, in the radial direction of the first flow channel 10, the distance between the free end 222 of the locating part 22 and the water outlet 10b is y, 1 mm≤y≤3 mm, so as to avoid that the extending length of the locating part 22 is too large to easily result in that the distance between the water outlet 10b and the gum corresponding to the tooth slot is far, and a triangular depression area at the described portion cannot be effectively flushed; At the same time, it is good for avoiding that the extending length of the locating portion 22 is too small to ensure the abutting and limiting position of the locating portion 22 and the gums, so that by reasonably setting the radial distance between the free end of the locating portion 22 and the water outlet 10b, it is good for ensuring the full cleaning of the tooth slit, and at the same time, it is good for ensuring the reliable stopping of the locating portion 22 and the gums, and to ensure the reliable positioning of the spray head 100.

For example, y can be 1 mm, or 1.5 mm, or 2 mm, or 2.8 mm, or 3 mm, etc.

In some embodiments of the present disclosure, as shown in FIG. 2, a length of extension of each limiting portion 21 in a direction away from the spray head main body 1 is L, 3 mm<L<7 mm, so as to ensure that the limiting portion 21 can relatively stably abut against the teeth surface, and the abutting position of the limiting portion 21 against the teeth is a central arch position of the teeth surface, even if the limiting portion 21 is deformed, the limiting portion 21 is not easily obstructed by the teeth surface, so as to ensure that the limiting portion 21 and the teeth are relatively suitable, guaranteeing the oral comfort. For example, L can be 3 mm, or 4 mm, or 5 mm, or 6 mm, or 7 mm, etc.

It can be understood that, if the extending length of the limiting portion 21 is too small, the supporting effect thereof will be relatively small, the limiting portion 21 is likely to abut against the area near the slit of the teeth, so that the tooth surface also prevents the expansion of the limiting portion 21, and the extending length of the limiting portion 21 is too large. On the one hand, the size of the limiting portion 21 is too large for a user to position the limiting portion 21 to enable the water outlet 10b to directly face the tooth slit; On the other hand, the larger size of the limiting portion 21 may cause discomfort in the oral cavity.

In some embodiments of the present disclosure, as shown in FIGS. 1 and 4, the joint between the spray head main body 1 and the limiting portion 21 is spaced apart from the water outlet 10b, the water outlet 10 b may be spaced apart from one side of the joint of the spray head main body 1 and the limiting portion 21 away from the water inlet 10a, thus, when the two limiting portions 21 contact with the adjacent teeth respectively, the water outlet 10b may protrude from the surface of the two limiting portions 21 formed at the joint with the spray head main body 1 and faced away from the water inlet 10a, which is good for enabling the water outlet 10b to be relatively close to the teeth slit so as to perform targeted flushing on the teeth slit, thereby ensuring a cleaning effect; Furthermore, the teeth slit between two adjacent teeth is provided with a triangular depression area at a portion close to the gums, and this depression area is deeper, so that a portion (for example, a protruding portion 112 described below) of the spray head main body 1 corresponding to the water outlet 10b can be accommodated, blinding can be avoided, alignment can be more accurate, and a certain anti-sputtering effect can also be achieved.

In some embodiments, as shown in FIG. 4, in the extending direction of the first flow channel 10, the interval between the joint of the spray head main body 1 and the limiting portion 21 and the water outlet 10b is x, 0.5 mm≤x≤3.5 mm, so that the described interval is reasonable, so as to ensure that the water outlet 10b does not extend beyond the connecting line of the free ends of the two limiting portions 21, at the same time, even if the part of the spray head main body 1 corresponding to the water outlet 10b contacts with the tooth face, the force arm corresponding to described part is short and not easy to deform, so that the user can perceive it in time to make a corresponding adjustment. For example, x can be 0.5 mm, or 1 mm, or 2.8 mm, or 3.1 mm, or 3.5 mm, etc.

For example, in the example of FIG. 1-5, the spray head main body 1 comprises a protruding portion 112, the protruding portion 112 is located at one end of the spray head main body 1, a water outlet 10b is defined at one end of the protruding portion 112. In the extending direction of the first flow channel 10, the protruding portion 112 is located on a side of the stopping structure 2 away from the water inlet 10a, the length of the protruding portion 112 in the extending direction of the first flow channel 10 is x, so as to ensure that the protruding portion 112 does not extend beyond a connecting line of free ends of the two limiting portions 21. Meanwhile, even if the protruding portion 112 contacts with the tooth surface, the force arm corresponding to the force applied on the protruding portion 112 is short, and the protruding portion 112 is not easy to deform, so that the user can perceive it in time to make a corresponding adjustment.

It should be understood that, in the present disclosure, the first flow channel 10 may extend along a straight line (as shown in FIG. 1 to FIG. 5) or along a curve. When the first flow channel 10 extends along the straight line, the extending direction of the first flow channel 10 is always invariant, and when the first flow channel 10 extends along the curve, the extending direction of the first flow channel 10 at a certain position may be understood as a tangential direction of the first flow channel 10 at the foregoing position.

In some embodiments, the spray head main body 1 comprises a protruding portion 112, one end of the protruding portion 112 defines a water outlet 10b, the protruding portion 112 protrudes from the stopping structure 2 in the water outlet direction, the end dimensions of one end of the protruding portion 112 having the water outlet 10b is not greater than 3 mm in the second direction. When the spray head 100 is used, the second direction corresponds to the width of the tooth slit, the protruding portion 112 protrudes relative to the stopping structure 2, and the dimension of the protruding portion 112 in the width direction of the tooth slit is not greater than 3 mm, for example, may be 3 mm, 2.5 mm, 2 mm, 1.5 mm, 1 mm, etc., so that the water outlet 10b can be better positioned between the teeth slit. Further, an end face of the end of the protruding portion 112 having the water outlet 10b is a circular surface, that is, a diameter of an end at which the water outlet 10b is located is not greater than 3 mm. In this way, the protruding portion 112 can better adapt to an teeth slit in various orientations, thereby forming a more stable positioning with the teeth slit.

In some embodiments of the present disclosure, as shown in FIG. 1 to FIG. 4, in the extending of the first flow channel 10, each limiting portion 21 extends beyond the water outlet 10b along the direction away from the water inlet 10a, then in the extending direction of the first flow channel 10, the free end of each limiting portion 21 is arranged at intervals downstream side of the water outlet 10b, so that the water inlet 10a and the water outlet 10b are located on one side of the connecting line between the free ends of the two limiting portions 21 on the longitudinal section of the first flow channel 10, that is, the water inlet 10a and the water outlet 10b are located at the same side of the connection line between the free ends of the two limiting portions 21.

When using the spray head 100, at least a free end portion of each of the limiting portions 21 is adapted to abut against teeth, so as to ensure that the water outlet 10b is spaced from a tooth surface of two adjacent teeth, furthermore, there is a sufficient and proper distance between the water outlet 10b and the tooth surface, so as to avoid the effect of the blocking hole on cleaning. At the same time, even if the limiting portion 21 is made of a material having a certain deformation capability, such as a soft material, it can still ensure that the water outlet 10b is spaced from the tooth surface, thereby ensuring the cleaning effect.

It should be noted that, “downstream” refers to a downstream in the flowing direction of the liquid in the first flow channel 10, a longitudinal section of the first flow channel 10 passes through a central axis of the first flow channel 10, the longitudinal section of the first flow channel 10 is perpendicular to a cross section of the first flow channel 10, and the cross section (which may be understood as a radial plane) of the first flow channel 10 is perpendicular to an extending direction of the first flow channel 10; The radial direction of the first flow channel 10 refers to the direction in a radial plane through the central axis of the first flow channel 10.

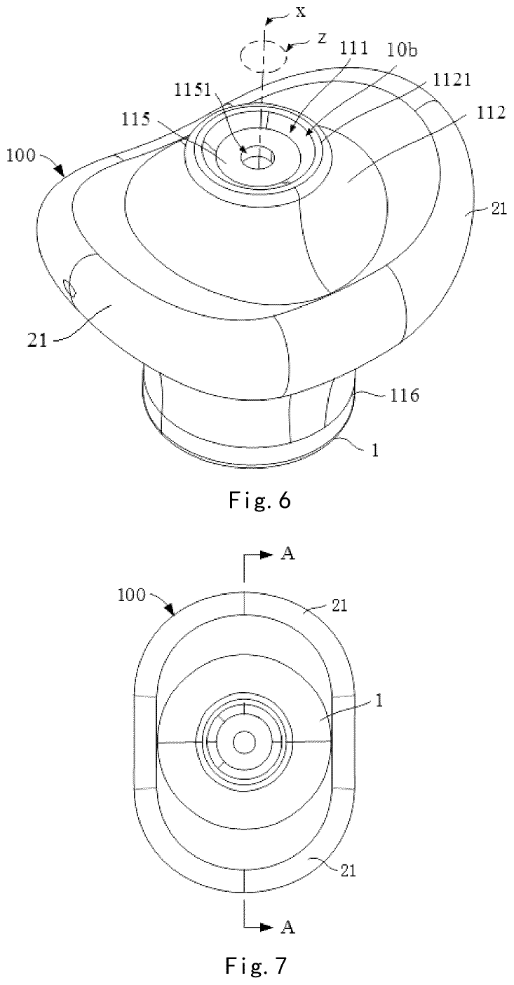

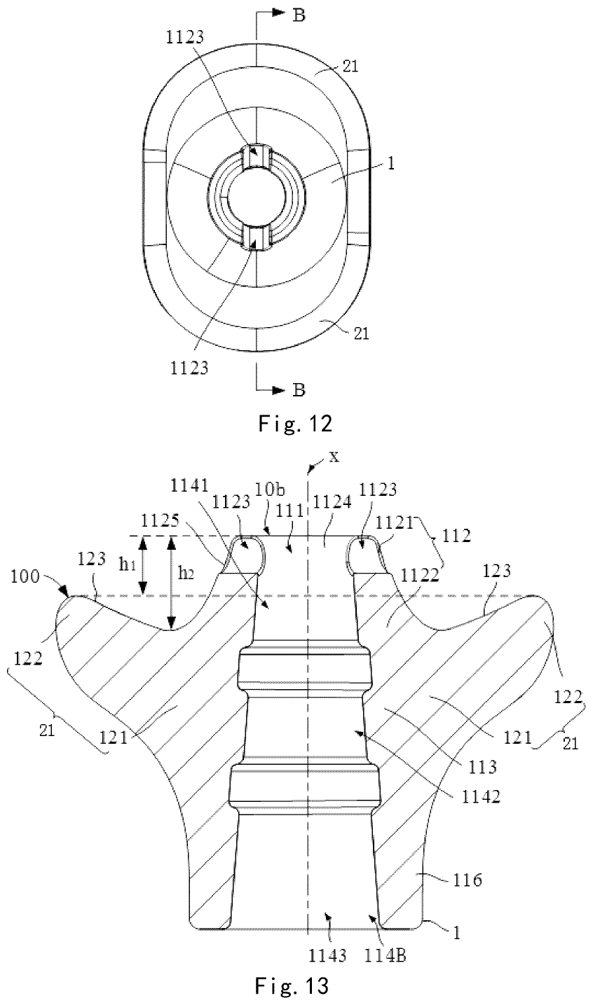

Of course, the present disclosure is not limited thereto. In other embodiments of the present disclosure, referring to FIGS. 6 to 15, in the extending direction of the first flow channel 10, the water outlet 10b extends beyond a connecting line of free ends 122 of any two of the limiting portions 21 in a direction away from the water inlet 10a; That is to say, the spray head main body 1 is provided with a outlet end 1121 corresponding to the water outlet 10b, and in the flowing direction of the water flow, the outlet end 1121 is located downstream of the connection line between the free ends 122 of any two limiting portions 21.

For example, in the embodiment shown in FIGS. 6-15, the spray head 100 comprises a spray head main body 1 and at least two limiting portions 21. The spray head main body 1 is formed with a first flow channel 10, the first flow channel 10 is provided with a water outlet 10b, and the spray head main body 1 is provided with a outlet end 1121 corresponding to the water outlet 10b.

The limiting portion 21 has a connecting end 121 and a free end 122 arranged opposite to each other. The connecting end 121 is connected between the two end parts of the spray head main body 1. In the radial direction of the spray head main body 1, the limiting portion 21 extends in a direction away from the spray head main body 1, and in the flow direction of the water flow, the outlet end 1121 is located downstream of a connection line between the free ends of any two of the limiting portions 21. That is, the height of the limiting portion 21 protruding in the water flow direction does not exceed the outlet end 1121 of the spray head main body 1. A radial direction of the spray head main body 1 may be a direction from one end of the spray head main body 1 to the other end thereof.

The limiting portion 21 may extend linearly along a radial direction y of the first flow channel 10, may also extend obliquely in a direction close to the outlet end 1121 along the radial direction y of the first flow channel 10, and may also extend obliquely in a direction away from the outlet end 1121 along the radial direction y of the first flow channel 10. It should be noted that, the oblique extension herein does not mean that the surface of the limiting portion 21 for contacting with the teeth of human is always a flat surface, and it may also be a curved surface or a profiled surface.

In some embodiments, the limiting portion 21 extends obliquely in a direction away from the spray head main body 1 and towards the outlet end 1121, which on purpose of enabling the limiting portion 21 to be relatively close to a tooth of user, so that the limiting portion 21 easily contacts the tooth, thereby achieving an auxiliary positioning function and ensuring that the water outflow direction is stable.

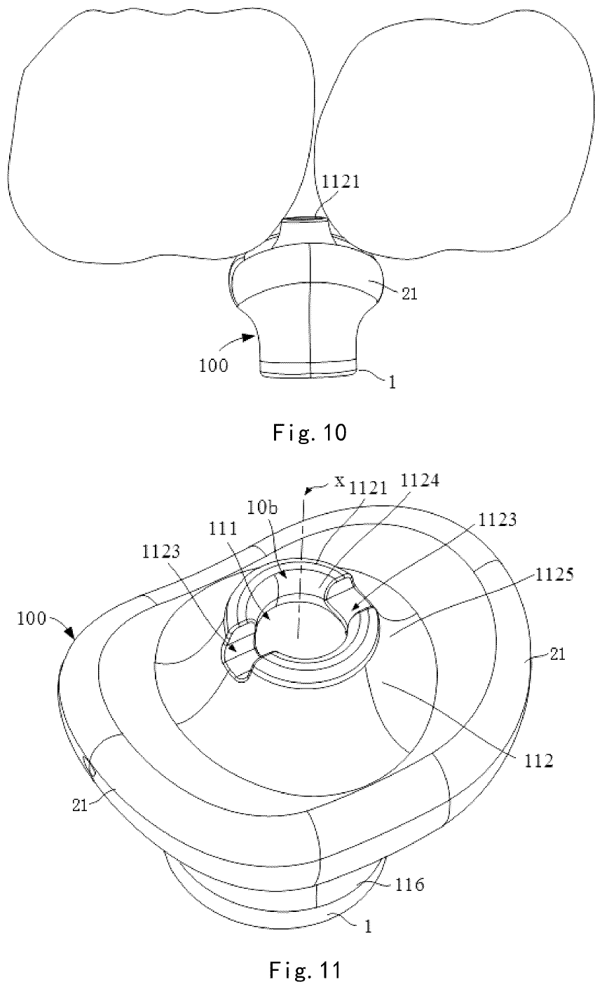

Specifically, the free end 122 is further away from the spray head main body 1 in the radial direction y of the first flow channel 10 with respect to the connecting end 121, and the projection of the free end 122 in the axial direction x of the first flow channel 10 is closer to the outlet end 1121 with respect to the projection of the connecting end 121 in the axial direction x of the first flow channel 10. Thus, referring to FIGS. 9 and 10, when the spray head 100 is cleaning the oral cavity of the user, the free end 122 of the limiting portion 21 is easy to abut against teeth in the oral cavity of the user, and the stability of the spray head 100 in the oral cavity of the user can be improved.

It should be noted that, in conjunction with FIGS. 9 and 10, when the spray head 100 cleans the oral cavity, the spray head 100 may be arranged between two adjacent teeth in the oral cavity, so as to spray water to the tooth slit between the two adjacent teeth through the water outlet 10b on the spray head main body 1, thereby achieving a cleaning effect. In conjunction with FIG. 9, the limiting portion 21 of the spray head 100 can abut against a tooth face of one of two adjacent teeth; and in conjunction with FIG. 10, the limiting portion 21 can also simultaneously abut against tooth faces of two adjacent teeth, which is not limited.

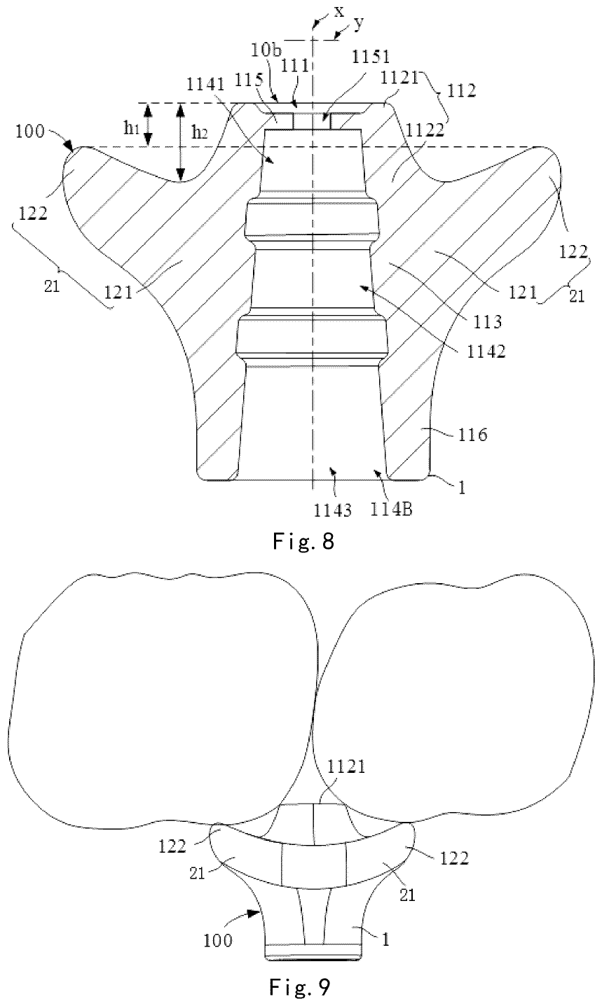

Referring to FIG. 8 again, the projection of the free end 122 of the limiting portion 21 in the axial direction x of the first flow channel 10 is located inside the projection of the spray head main body 1 in the axial direction x of the first flow channel 10, that is, the projection of the free end 122 in the axial direction x of the first flow channel 10 does not protrude out of the spray head main body 1.

Further, the free end 122 and the outlet end 1121 are disposed at an interval of an axial direction x of the first flow channel 10. Then, in the axial direction x of the first flow channel 10, the outlet end 1121 protrudes from the free end 122. In this way, when the user's oral cavity is cleaned, the protruding outlet end 1121 is closer to the teeth compared with the free end 122. The protruding outlet end 1121 may be disposed at the teeth slit between two teeth first, which helps improving the positioning speed of the spray head 100 at the teeth slit. Furthermore, since the teeth slit is provided with a concave portion, the protruding outlet end 1121 disposed in the concave portion is not easy to slide out, which is good for improving the positioning stability of the spray head 100 at the teeth slit.

After the protruding outlet end 1121 is disposed at the teeth slit, the limiting portion 21 will be in contact with the tooth, which can further improve the positioning stability of the spray head 100 at the teeth slit, so that the water outlet direction of the spray head 100 is stable, and the teeth slit can be washed steadily, improving the cleaning effect.

It should be noted that, the projection of the free end 122 of the limiting portion 21 in the axial direction x of the first flow channel 10 is closer to the outlet end 1121 relative to the projection of the connecting end 121 in the axial direction x of the first flow channel 10, which not only facilitates the contact between the free end 122 and the teeth, but also serves the function of blocking the fluid ejected from the outlet end 1121, so as to reduce the sputtering out of the mouth after the fluid is flushed to the tooth face.

It should be noted that, an axial direction x of the first flow channel 10 may be an extending direction of the first flow channel 10, and a radial direction y of the first flow channel 10 may be a direction perpendicular to the axial direction x. The extending direction of the first flow channel 10 may be a straight line direction, a curved line direction, or the like, which is not limited herein.

The free ends 122 of the limiting portions 21 are disposed at intervals in the circumferential direction z of the first flow channel 10, so that the free ends 122 of the limiting portions 21 are independent relative to each other. The contact between the free ends 122 and the teeth does not affect each other, which facilitates the respective ends 122 to deform correspondingly in the shape of the tooth face corresponding to the teeth, thereby improving the stability of contact between the spray head 100 and the teeth. The circumferential direction z of the first flow channel 10 may be a circular direction around the extending direction of the first flow channel 10.

The limiting portion 21 may be elastic only at the free end 122, or the whole limiting portion 21 may be elastic. The elasticity means that deformation may occur when force is applied, and the limiting portion 21 as a whole or the free end 122 has elasticity, which can adapt to teeth of different sizes and shapes, thereby improving the usage range of the spray head 100.

The outlet end 1121 of the spray head main body 1 may also have elasticity, so that a certain deformation can be generated according to the depression size of the tooth slit, so that the limiting portion 21 can contact with teeth, thereby improving the usage range of the spray head 100. Of course, the spray head main body 1 may also have elasticity as a whole, which is not limited thereto.

When the spray head 100 is in use, the outlet end 1121 may or may not contact teeth, which is not limited thereto.

It should be noted that the limiting portion 21 as a whole, or the free end 122 or the outlet end 1121 has elasticity, and can also damp vibration transmitted to teeth when the spray head 100 is used, thereby improving the user experience.

In the embodiment of the present disclosure, the portion of the spray head 100 having elasticity may be made of a material such as soft rubber, and the limiting portion 21 and the portion of the spray head main body 1 having elasticity may be made of the same material, or may be made of different materials, which is not limited herein.

Referring to FIG. 8, the spray head main body 1 comprises a protruding portion 112 and a first connecting portion 113, the protruding portion 112 forms at least a portion of the first flow channel 10, the protruding portion 112 has a outlet end 1121 and a first end 1122 opposite to the outlet end 1121, and a water outlet 10b is formed at the outlet end 1121; The first connecting portion 113 is connected to the first end 1122 of the protrusion portion 112, and the connecting end 121 of the limiting portion 21 is connected to the first connecting portion 113.

The protruding portion 112 may form a portion of the first flow channel 10, that is, a portion of the first flow channel 10 is formed on the protruding portion 112, and the other part of the first flow channel 10 is formed on the other part of the spray head main body 1 except the protruding portion 112, for example, the first connecting portion 113, etc. The protruding portion 112 may also form the entire first flow channel 10. The first flow channel 10 is a passage for transporting fluid on the spray head main body 1 when the spray head 100 is used.

Referring to FIG. 11 to FIG. 13, the outlet end 1121 of the protruding portion 112 is formed with at least one notch 1123, and the radial direction y of the first flow channel 10 of the notch 1123 runs through the protruding portion 112; For example, the protruding portion 112 has a first inner surface 1124 that forms the first flow channel 10 and a first outer surface 1125 opposite the first inner surface 1124, and a notch 1123 extends through the first inner surface 1124 and the first outer surface 1125 in the radial direction y of the first flow channel 10. The arrangement of the notch 1123 can avoid blockage at the water outlet 10b affecting water outflow, and enables the protruding portion 112 to be deformed more easily, thereby being better adapted to a teeth slit.

Further, each notch 1123 is disposed corresponding to the radial direction y of the first flow channel 10 where the limiting portion 21 is located. It should be understood that the radial direction y of the first flow channel 10 may be a plurality of directions, among the plurality of radial directions y of the first flow channel 10 corresponding to the notch 1123, the radial direction y corresponding to the limiting portion 21 allows the fluid exiting through the notch 1123 may be blocked by the corresponding limiting portion 21, thereby preventing the fluid from splashing.

For example, the dimension of the notch 1123 in the axial direction x of the first flow channel 10 is less than or equal to the dimension of the first flow channel 10 in the axial direction x thereof, so that the dimension of the notch 1123 in the axial direction x of the first flow channel 10 is not too large, the structure of the protruding portion 112 has good strength, and is not prone to vibration cracking after a long time of use. At the same time, the size of the notch 1123 in the axial direction x of the first flow channel 10 will not be too large, and it is also beneficial for the protruding portion 112 to have a certain distance from the jet tube 101A after being deformed, so that the jet tube 101A will not directly contact teeth, which will be further described below.

Please refer to FIG. 13, the protruding portion 112 has a first outer surface 1125, and in a direction from the first end 1122 to the outlet end 1121, the dimension of the first outer surface 1125 in the radial direction y of the first flow channel 10 gradually decreases; and/or the dimension h₂ of the protruding portion 112 in the axial direction x of the first flow channel 10 is greater than or equal to 0.5 mm and less than or equal to 3 mm.

By setting the dimension of the first outer surface 1125 in the radial direction y of the first flow channel 10 to satisfy the described condition, the protruding portion 112 is more likely to protrude into the alveolar gap between two teeth, and is more likely to quickly position the spray head 100; By reasonably defining the dimension h₂ of the protruding portion 112 in the axial direction x of the first flow channel 10, it is more beneficial for the outlet end 1121 of the protruding portion 112 to extend into the teeth slit between two adjacent teeth. Since the depth of the teeth slit is relatively limited, if h₂ is greater than 3 mm, there may exist the problem that the free end 122 cannot contact teeth; If h₂ is less than 0.5 mm, the free end 122 may contact the teeth before the water outlet 1121, which is adverse to the positioning of the water outlet 1121 at the teeth slit.

It should be noted that the dimension h₂ of the protruding portion 112 in the axial direction x of the first flow channel 10 refers to a distance from a boundary between the protruding portion 112 and the limiting portion 21 to the point of the protruding portion 112 farthest away from the free end 122 in the axial direction x of the first flow channel 10.

Therein, h₂ may specifically be 0.5 mm, 0.8 mm, 1 mm, 1.5 mm, 2 mm, 2.5 mm, 3 mm, and the like, which is not limited herein.

In some embodiments, as shown in FIGS. 2, 13 and 14, the angle between a water outlet direction of the spray head main body 1 and a line connecting free ends 122 of the at least two limiting portions 21 is greater than or equal to 80° and less than or equal to 100°. In this way, when the limiting portion 21 contacts the teeth, the water outlet direction of the spray head main body 1 can be roughly aligned with the tooth slit, avoiding that the water outlet direction of the spray head main body 1 is inclined to impact the teeth surfaces, the flushing effect of the fluid returns backward after the tooth surface collision becomes weaker, the cleaning effect becomes poor, and the fluid returns backwards easily impacts the gums, resulting in bleeding of gums.

It should be noted that, the spray head 100 may comprise two limiting portions 21, or three limiting portions 21, etc., and when the spray head 100 comprises at least three limiting portions 21, the angle between the line connecting free ends 122 of any two of the three limiting portions 21 and the water outlet direction of the spray head main body 1 may be greater than or equal to 80 degrees and less than or equal to 100 degrees; Alternatively, the angle between the line connecting the free ends 122 of the at least two limiting portions 21 and the water outlet direction of the spray head main body 1 can be greater than or equal to 80 degrees and less than or equal to 100 degrees.

Wherein, an angle between a water outlet direction of the spray head main body 1 and a line connecting free ends 122 of the two limiting portions 21 may specifically be 80 degrees, 85 degrees, 90 degrees, 95 degrees, 100 degrees, or the like, which is not limited herein.

In some embodiments, the spray head 100 satisfies at least one of the following conditions:
Condition A1, the distance h₁ between the free end 122 and the outlet end 1121 in the axial direction x of the first flow channel 10 is greater than or equal to 0.1 mm and less than or equal to 1.5 mm. By reasonably defining the dimension h₁ of the outlet end 1121 protruding from the free end 122 in the axial direction x of the first flow channel 10, it is more beneficial for the outlet end 1121 to extend into the teeth slit between two adjacent teeth. Since the depth of the teeth slit is relatively limited, if h1 is greater than 1.5 mm, there may exist the problem that the free end 122 cannot contact teeth; If h₁ is less than 0.1 mm, the free end 122 may contact the teeth before the water outlet 1121, which is adverse to the positioning of the water outlet 1121 at the teeth slit.

It should be noted that, the distance h₁ between the free end 122 and the outlet end 1121 in the axial direction x of the first flow channel 10 refers to the distance between a point of the free end 122 closest to the outlet end 1121 and a point of the outlet end 1121 farthest from the free end 122 in the axial direction x of the first flow channel 10.

Therein, h₁ may specifically be 0.1 mm, 0.5 mm, 0.8 mm, 1.0 mm, 1.2 mm, 1.5 mm, and the like, which is not limited herein.
Condition A2, the spray head 100 comprises two limiting portions 21, and the two limiting portions 21 are located at two opposite sides of the spray head main body 1 in the radial direction y of the first flow channel 10, so that the structure of the spray head 100 is simple, and the positioning stability between the spray head 100 and teeth is better.
Condition A3, the thickness of the limiting portion 21 in the axial direction x of the first flow channel 10 decreases in the direction from the connection end 121 to the free end 122. Therefore, the free end 122 has a small thickness and is easily deformed to adapt to more types of teeth; and the thickness of the limiting portion 21 is smoothly deformed, so that the limiting portion 21 is prevented from aging and cracking, and the service life is improved.
Condition A4, in the direction from the connecting end 121 to the free end 122, the abutting surface 123 of the limiting portion 21 close to the water outlet 10b swells in the direction away from the spray head main body 1; It may be understood that, the projection of the limiting portion 21 onto the first plane is arc-shaped, and the first plane is parallel to the axial direction x of the first flow channel 10 and parallel to the extending direction from the connecting end 121 of the limiting portion 21 to the free end 122 of the first flow channel 10. Thus, the abutting surface 123 of the limiting portion 21 can conform to the shape of the teeth, and the positioning is stable. Certainly, in the direction from the connecting end 121 to the free end 122, the abutting surface 123 of the limiting portion 21 may also be smooth, and may be flexibly designed according to actual requirements.
Condition A5: the abutting surface 123 of the limiting portion 21 swells from the circumferential direction z of the first flow channel 10 to the direction away from the spray head main body 1; It may be understood that, the projection of the limiting portion 21 onto the second plane is arc-shaped, and the second plane is parallel to the axial direction x of the first flow channel 10 and perpendicular to the extending direction from the connecting end 121 of the limiting portion 21 to the free end 122 of the first flow channel 10. Certainly, from the circumferential direction z of the first flow channel 10, the abutting face 123 of the limiting portion 21 may also be smooth, and may be designed flexibly in combination with practical requirements.
Condition A6, the limiting portion 21 is smoothly transitionally connected to the spray head main body 1, so as to avoid aging and cracking during repeated deformation and rebound for a long time. Wherein, the limiting portion 21 is in smooth transition connection with the spray head main body 1, which may be understood as that the outer surface of the limiting portion 21 is in smooth transition connection with the outer surface of the spray head main body 1.
Condition A7, the limiting portion 21 and the spray head main body 1 all have elasticity.

It should be noted that, in the embodiment of the present disclosure, the spray head 100 may be an integrally formed structure, so that the spray head 100 has better structural stability.

The nozzle 200 of an oral irrigator according to the embodiment of the second aspect of the present disclosure comprises a spray head 100 and a spray rod 101. The spray head 100 is the spray head 100 according to the embodiment of the first aspect of the present disclosure. The spray rod 101 defines a second flow channel 1010. The spray head 100 is provided at one end of the spray rod 101, and the water inlet 10a is in communication with the second flow channel 1010, so that the cleaning liquid in the second flow channel 1010 flows into the first flow channel 10 via the water inlet 10a, and flows out through the water outlet 10b.

It can be seen that, because the spray rod 101 has a certain length, and the length of the spray rod 101 is greater than the outer diameter of the spray rod 101 (the outer contour of the cross section of the spray rod 101 is not limited to a circle, may also be a polygon, or other shapes such as an irregularly, etc.), when the nozzle 200 is in use, the spray head 100 and a part of the spray rod 101 may extend into the oral cavity without excessive opening of the mouth, so as to ensure the experience effect.

According to the nozzle 200 of the oral irrigator of the embodiments of the present disclosure, by using the described spray head 100, stable limiting relative to the teeth can be achieved, and at the same time, effective cleaning of the teeth slit can be achieved.

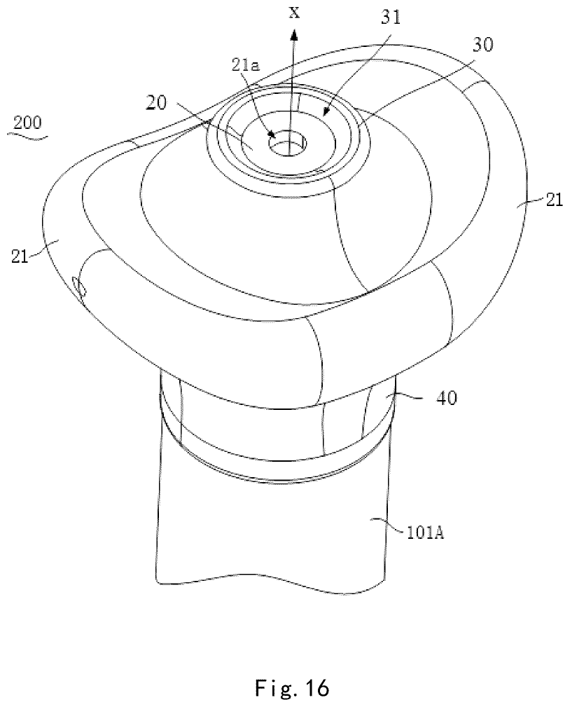

In some embodiments, as shown in FIGS. 16-21, the spray rod 101 is configured as a jet tube 101A, the second flow channel 1010 has a second water outlet 112a, the spray head main body 1 further comprises a deformation portion 20, that is, the nozzle 200 comprises the effuser 101A and the deformation portion 20.

The jet tube 101A has a second flow channel 1010, which comprising a second water inlet (not shown) and a second water outlet 112a, and the liquid in the second flow channel 1010 may flow from the first water inlet to the second water outlet 112a. The deformation portion 20 is located at one side where the second water outlet 112a of the jet tube 101A is located. The deformation portion 20 comprises a third flow channel 21a in communication with the second flow channel 1010. When the liquid flows through the third flow channel 21a, the deformation portion 20 is deformed so that the liquid is sprayed in a flared manner.

The deformation portion 20 is easily deformed when being subjected to a force. Specifically, in the embodiment of the present disclosure, when a water flow flows in the third flow channel 21a, the deformation portion 20 is deformed by a pressing force applied by the water flow to an inner wall of the third flow channel 21a, then the third flow channel 21a is outwardly expanded and deformed, and a liquid is sprayed in a flared manner.

In addition, spraying the liquid in a flared manner can expand the coverage of the liquid, thereby increasing the cleaning area of the nozzle 200 in the oral cavity. Furthermore, the deformation portion 20 can generate a large deformation when the water flow pressure is high, so as to disperse the water flow and relieve the water flow pressure, while generate a small deformation when the water flow pressure is low, so as to reduce the influence on the water flow pressure. In this way, the nozzle 200 can achieve self-adaptive pressure water outflow, and the phenomenon of gum injury (such as bleeding) is effectively avoided.

Since the third flow channel 21a can be outwardly expanded and deformed under the action of the squeezed force of the water flow, in the embodiment of the present disclosure, the cross-sectional area of the third flow channel 21a may be constant, gradually increased, gradually decreased or a combination thereof in the direction x of the liquid flow, so that the design of the third flow channel 21a is more diversified, the design accuracy requirement of the third flow channel 21a is reduced, and the manufacturing cost of the deformation portion 20 is reduced.

The liquid flow direction x may be substantially the same as the axial direction of the flow channel on the nozzle 200. Specifically, if the nozzle 200 includes the jet tube 101A and the deformation portion 20, the liquid flow direction x is substantially a combination of the axial direction of the second flow channel 1010 of the jet tube 101A and the axial direction of the third flow channel 21a of the deformation portion 20, and is directed from the second flow channel 1010 to the third flow channel 21a. An axial direction of the second flow channel 1010 may be an extending direction of the second flow channel 1010, and an axial direction of the third flow channel 21a may be an extending direction of the third flow channel 21a. The extending direction of the second flow channel 1010 and the extending direction of the third flow channel 21a may be a straight line direction or a curved line direction, which is not limited herein.

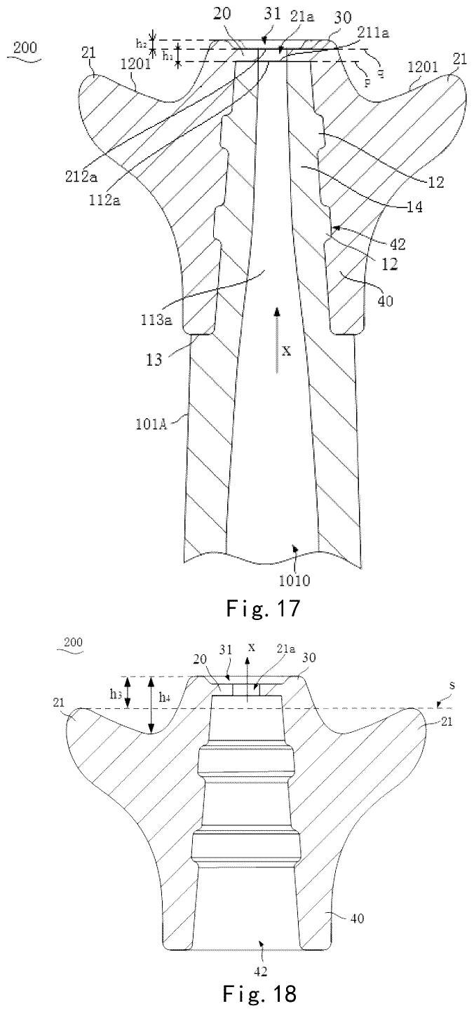

As shown in FIG. 17, the cross-sectional area of the water outlet section 113a of the second flow channel 1010 may be gradually reduced or first reduced and then unchanged in the flow direction x of the liquid, so as to form the cavitation liquid, and there is micro bubbles in the cavitation liquid. In this case, the flow channel is narrowed, the liquid flowing to the third flow channel 21a has a greater impact force, and the impact force may be buffered by the third flow channel 21a of the deformation portion 20.

In the embodiment of the present disclosure, the water outlet section 113a of the second flow channel 1010 may be directly connected with the third flow channel 21a, or may be connected with the third flow channel 21a via an intermediate flow channel (not shown in the figure). If the water outlet section 113a of the second flow channel 1010 is directly connected with the third flow channel 21a, the deformation portion 20 may be directly attached to the jet tube 101A, and the third flow channel 21a of the deformation portion 20 is directly connected with the second flow channel 1010 of the jet tube 101A, thereby simplifying the assembling flow of the nozzle 200 and improving the assembling efficiency.

If the water outlet section 113a of the second flow channel 1010 is directly connected with the third flow channel 21a via an intermediate flow channel, an intermediate structure (not shown in the figure) is further provided between the jet tube 101A and the deformation portion 20, however, the arrangement of the intermediate structure can reduce the design accuracy requirements of the jet tube 101A and the deformation portion 20, so that it can be adapted to more types of jet tube 101A and deformation parts 20 only by modifying the intermediate flow channel of the intermediate structure, and even when the intermediate flow channel is a curved flow channel, the included angle of the second flow channel 1010 and the third flow channel 21a can be arranged, etc., In addition, the volume form of the intermediate structure is smaller compared with that of the jet tube 101A, and therefore the adjustment of the intermediate flow channel is more flexible and better operable compared with the adjustment of the second flow channel 1010 of the jet tube 101A. The intermediate flow channel and the jet tube 101A and/or the deformation portion 20 may be detachable connection, so as to facilitate assembly and replacement.

It should be noted that, if the deformation portion 20 is attached to the jet tube 101A, the deformation portion 20 and jet tube 101A may be detachable connection, so as to facilitate assembly and replacement. For example, the deformation portion 20 and the jet tube 101A may be detachably connected by snap-fitting. Of course, the deformation portion 20 and the jet tube 101A may also be fixedly connected by means of bonding, integral forming, etc., which is not limited thereto.

As shown in FIG. 17, the third flow channel 21a has a third water inlet 211a abutting against the second water outlet 112a. If the imaginary surface defined to be perpendicular to the liquid flow direction x and located between the deformation portion 20 and the jet tube 101A is the first reference surface p, the projection of the contour line of the second water outlet 112a on the first reference surface p is the first projection, and the projection of the contour line of the third water inlet 211a on the first reference surface p is the second projection. In the direction perpendicular to the liquid flow direction x, the distance between the first projection and the second projection is less than or equal to 0.1 mm.

Therein, along the direction perpendicular to the liquid flow direction x, the distance between the first projection and the second projection is less than or equal to 0.1 mm, in other words, along the direction perpendicular to the liquid flow direction x, the maximum distance between the first projection and the second projection does not exceed 0.1 mm, thus, the contour line of the second water outlet 112a is substantially aligned with the contour line of the third water inlet 211a, and the smooth flow of the liquid from the second flow channel 1010 to the third flow channel 21a is improved.

It should be noted that the first projection may be coincident with the second projection, the first projection may also be at least partly located inside the second projection, and the second projection may also be at least partly located inside the first projection. When the first projection and the second projection coincide with each other, the contour line of the second water outlet 112a is aligned with the contour line of the third water inlet 211a, which may be understood as a smooth transitional connection between the inner wall of the second flow channel 1010 and the inner wall of the third flow channel 21a, so that when the liquid flows from the second flow channel 1010 to the third flow channel 21a, no interfacial resistance is formed, the liquid flows smoothly, and the water flow is not disturbed.

When at least part of the first projection is located inside the second projection, only when the water flow pressure exceeds a certain pre-set value, the deformation portion 20 is significantly deformed, the water flow pressure is influenced. However, when the water flow pressure is lower than the pre-set value, the deformation portion 20 hardly deforms, and has little influence on the water flow pressure. Compared with the coincidence of the first projection and the second projection, if equal deformation of the deformation portion 20 is required, the required water flow pressure will be higher.

When at least a portion of the second projection is located on the inner side of the first projection, a larger range of control water flow pressure of the nozzle 200 can be achieved.

As shown in FIG. 17, the thickness h₁ of the deformation portion 20 along the liquid flow direction x is equal to or greater than 0.15 mm and equal to or less than 0.5 mm, so that the deformation portion 20 can achieve both excellent deformation ability and water pressure regulation ability. If the thickness h₁ of the deformation portion 20 in the liquid flow direction x is greater than 0.5 mm, the deformation capability is poor and the water flow pressure adjustment capability is poor; and if the thickness h₁ of the deformation portion 20 in the liquid flow direction x is less than 0.15 mm, the deformation amplitude is also small, and the water flow pressure cannot be effectively adjusted.

For example, the thickness h₁ of the deformation portion 20 along the liquid flow direction x may be 0.15 mm, 0.2 mm, 0.3 mm, 0.4 mm, 0.5 mm, or the like, and is not limited thereto.

In some embodiments, the deformation portion 20 may be located at a water outflow side of the nozzle 200, that is, when the nozzle 200 is used, the deformation portion 20 is close to a tooth of a user, for example, the deformation portion 20 may directly abut against the tooth of the user. The deformation portion 20 may be deformed, and when the deformation portion 20 abuts against the teeth of the user, the vibration transmitted to the teeth when the nozzle 200 is used can be attenuated by generating deformation, thereby improving the user experience.

In some other embodiments, as shown in FIGS. 16-21, the nozzle 200 further includes a soft flange 30, and the soft flange 30 may be located at a water outlet side of the nozzle 200. Specifically, the third flow channel 21a also comprises a third water outlet 212a opposite to the third water inlet 211a, the soft flange 30 is connected to a side of the deformation portion 20 where the third water outlet 212a is located, and along the liquid flow direction x, the soft flange 30 protrudes from the deformation portion 20. Thus, when the nozzle 200 is in use, the soft flange 30 is closer to user's teeth than the deformation portion 20, and the soft flange 30 abuts against the user's teeth to avoid contact between the deformation portion 20 and the teeth, so that the distance between the third water outlet 212a of the deformation portion 20 and the teeth can be extended to avoid blockage of the third water outlet 212a.

The soft flange 30 is a soft material member, and is deformed when subjected to a general acting force (for example, an acting force applied to the nozzle 200 when the user uses the nozzle 200), in this way, when the soft flange 30 abuts against the teeth of the user, the vibration transmitted to the teeth when the nozzle 200 is used can also be attenuated by deformation, thereby improving the user experience.

As shown in FIG. 17, if a virtual plane perpendicular to the liquid flow direction x and located between the deformation portion 20 and the soft flange 30 is defined as a second reference plane q, the projection of the soft flange 30 on the second reference plane q is located on the periphery of the projection of the third water outlet 212a on the second reference plane q, a gathering cavity 31 is formed between the soft flange 30 and the deformation portion 20, and the gathering cavity 31 is connected with the third flow channel 21a via the third water outlet 212a. A gathering cavity 31 is formed at the side of the third water outlet 212a of the third flow channel 21a, which can play the role of gathering liquid and preventing the liquid from being splashed in the oral cavity.

As shown in FIG. 17, the projection of the soft flange 30 on the second reference plane q is located at the periphery of the projection of the third water outlet 212a on the second reference plane q, so that the projection of the contour line of the aperture of the gathering cavity 31 near the deformation portion 20 on the second reference plane q is located at the periphery of the projection of the third water outlet 212a on the second reference plane q, That is, the gathering cavity 31 is connected to the third flow channel 21a in a non-smooth transition manner, so that when the soft flange 30 contacts teeth to deform, this deformation is not easily transmitted to the deformation portion 20, and thus the third flow channel 21a is not easily blocked.

The thickness h₂ of the soft flange 30 along the fluid flow direction x is greater than or equal to 0.5 mm and less than or equal to 2 mm, so that the soft flange 30 can have better deformation capacity and the deformation is not easily transmitted to the deformation portion 20. If the thickness h₂ of the soft flange 30 in the direction x of fluid flow is greater than 2 mm, when the soft flange 30 is in contact with the tooth surface, the excessive long soft flange 30 may block the flow channel of the nozzle 200 after being deformed and block water outflow.

If the soft flange 30 is not in contact with the tooth surface, the length of the soft flange 30 in the liquid flow direction x is too long to be deformed continuously under the impact of the water flow, as a result, the water flow is unstable and prone to splashing. If the thickness h₂ of the soft flange 30 in the liquid flow direction x is less than 0.5 mm, the deformation of the soft flange 30 is easily transmitted to the deformation portion 20, and the third flow channel 21a of the deformation portion 20 is easily blocked.

Specifically, along the liquid flow direction x, the thickness h₂ of the soft flange 30 may be 0.5 mm, 0.8 mm, 1.0 mm, 1.3 mm, 1.5 mm, 2 mm, or the like, which is not limited herein.

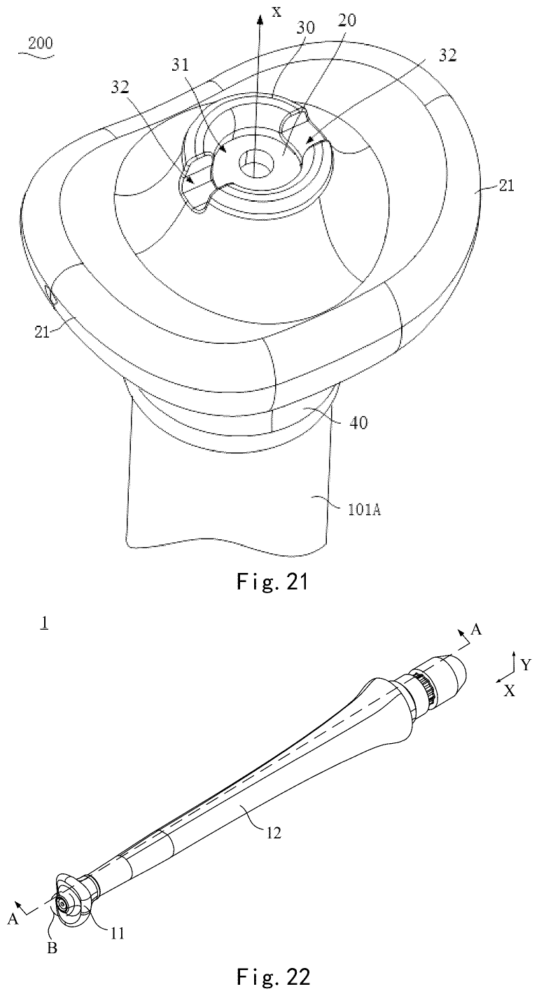

Please refer to FIG. 21, a notch 32 is formed on a side of the soft flange 30 away from the deformation portion 20, the notch 32 penetrates through the soft flange 30 in a direction perpendicular to the liquid flow direction x, and the notch 32 is communicated with the gathering cavity 31. The arrangement of the notch 32 can avoid blockage of the nozzle 200, and the arrangement of the notch 32 enables the soft flange 30 to be deformed more easily, thereby being able to adapt to more teeth slit depression depths, and improving the application range of the nozzle 200.

The notch 32 is provided at a side of the soft flange 30 away from the deformation portion 20, and does not extend to the deformation portion 20, which can ensure the structural strength of nozzle 200 is better, and the problem of vibration crack is not easy to occur after long-time use; Furthermore, it is beneficial for the soft flange 30 to have a certain distance between it and the jet tube 101A after deformation, so that the jet tube 101A will not directly contact the teeth.

Along the liquid flow direction x, the depth of the notch 32 is greater than or equal to half of the thickness h₂ of the soft flange 30, so that the depth of the notch 32 along the liquid flow direction x is not too small, thereby facilitating deformation of the soft flange 30.

In some embodiments, the soft flange 30 may be configured as a portion of the protruding portion 112 described herein above; At this time, if the soft flange 30 is formed with the notch 32, the notch 32 is the notch 1123 of the protruding portion 112. Alternatively, the soft flange 30 may be configured to be independent of the protruding portion 112, in this case, the soft flange 30 may be disposed on the end surface of the protruding portion 112, such as the water outlet end 1121.

Referring to FIGS. 17-21, the nozzle 200 further includes a connecting sleeve 40. The jet tube 101A comprises a water outlet end 14 corresponding to the second water outlet 112a. The connecting sleeve 40 is sleeved at least on the water outlet end 14, and the connecting sleeve 40 is connected to the deformation portion 20. Namely, the deformation portion 20 can be connected to the jet tube 101A via the connecting sleeve 40. Compared with the deformation portion 20 being directly connected to the jet tube 101A, the connecting area between the deformation portion 20 and the jet tube 101A is able to increase, and the connection is more reliable. It should be noted that, in the embodiment of the present disclosure, the deformation portion 20 may be directly connected to the jet tube 101A without the help of the connecting sleeve 40.

If the deformation portion 20 is connected to the jet tube 101A by the connecting sleeve 40, the deformation portion 20 may be connected to the connecting sleeve 40 as a whole, and a mounting groove 42 is formed between the deformation portion 20 and the connecting sleeve 40 in a surrounding manner. Part of the jet tube 101A is embedded in the mounting groove 42, and an end face of the jet tube 101A may abut against the deformation portion 20, so as to constrain the depth of the jet tube 101A inserted into the connecting sleeve 40 by the deformation portion 20.

A limiting protrusion is provided on the inner surface of the connecting sleeve 40 and/or the surface of the deformation portion 20 facing the jet tube 101A, the limiting protrusion protrudes relative to the inner surface of the connecting sleeve 40 and/or the surface of the deformation portion 20 facing the jet tube 101A, the jet tube 101A is provided with a limiting groove corresponding to the limiting protrusion, and the limiting protrusion is located in the corresponding limiting groove. And/or the inner surface of the connecting sleeve 40 and/or the surface of the deformation portion 20 facing the jet tube 101A is provided with a limiting groove 43, the limiting groove 43 is recessed relative to the inner surface of the connecting sleeve 40 and/or the surface of the deformation portion 20 facing the jet tube 101A, the jet tube 101A is provided with a limiting protrusion 12 corresponding to the limiting groove 43, and the limiting protrusion 12 is located in the corresponding limiting groove 43. The arrangement of the limiting protrusion 12 and the limiting groove 43 enables the depth of the jet tube 101A extending into the connecting sleeve 40 to be defined between the jet tube 101A and the connecting sleeve 40/deformation portion 20 by means of the limiting protrusion 12 and the limiting groove 43, thereby improving the assembly positioning precision of the jet tube 101A and the connecting sleeve 40.

The limiting protrusion 12 may be an annular shape surrounding the circumference of the jet tube 101A, which is not limited herein.

An outer surface of the jet tube 101A may include a step surface 13, and an end of the connecting sleeve 40 away from the deformation portion 20 may abut against the step surface 13, so as to further improve the connection reliability of the jet tube 101A and the connecting sleeve 40.

In the outer surface of the connecting sleeve 40, a cross section of at least one end close to the deformation portion 20 gradually decreases in the liquid flow direction x, so that the nozzle 200 can be more easily inserted into the slit between two teeth, and the quick positioning of the nozzle 200 is more easily achieved.

The whole of the connecting sleeve 40 or the part connecting the deformation portion 20 may be made of a soft material, and the soft material of the connecting sleeve 40 may be the same as the material for manufacturing the deformation portion 20, so as to improve the connection reliability therebetween. Of course, the connecting sleeve 40 and the deformation portion 20 may also be an integrally formed structure, which is not limited herein.

In some embodiments, the connecting sleeve 40 may be formed as the second connecting portion 116 described above in this application.

Please refer to FIGS. 16 to 18, the limiting portion 21 is connected with the connecting sleeve 40, and the limiting portion 21 is connected between the two ends of the connecting sleeve 40. The limiting portion 21 is smoothly transitionally connected to the connecting sleeve 40, so as to avoid aging and cracking during repeated deformation and rebound for a long time. Wherein, the limiting portion 21 is in smooth transition connection with the connecting sleeve 40, which may be understood as that the outer surface of the limiting portion 21 is in smooth transition connection with the outer surface of the connecting sleeve 40.

Along the direction perpendicular to the liquid flow direction x, the limiting portion 21 may extend in a direction away from the connecting sleeve 40, and the limiting portion 21 can be in contact with the tooth surface when the nozzle 200 is in use, thereby improving the positioning stability of the nozzle 200 in the oral cavity.

The limiting portion 21 may extend linearly along a direction perpendicular to the liquid flow direction x, or may extend obliquely in a direction close to the deformation portion 20 along a direction perpendicular to the liquid flow direction x, or may also extend obliquely in a direction away from the deformation portion 20 along a direction perpendicular to the liquid flow direction x. It should be noted that, the oblique extension herein does not mean that the surface of the limiting portion 21 for contacting with the teeth of human is always a flat surface, and it may also be a curved surface or a profiled surface.

In some embodiments, in a direction away from the connecting sleeve 40, the limiting portion 21 extends obliquely towards the direction near deformation portion 20, that is, along the fluid flow direction x, the end of the limiting portion 21 far away from the connecting sleeve 40 is located downstream of the end of the limiting portion 21 connecting the connecting sleeve 40, which on purpose of enabling the limiting portion 21 to be relatively close to teeth of user, so that the limiting portion 21 easily contacts the tooth surface, thereby achieving an auxiliary positioning function and ensuring that the water outflow direction is stable.

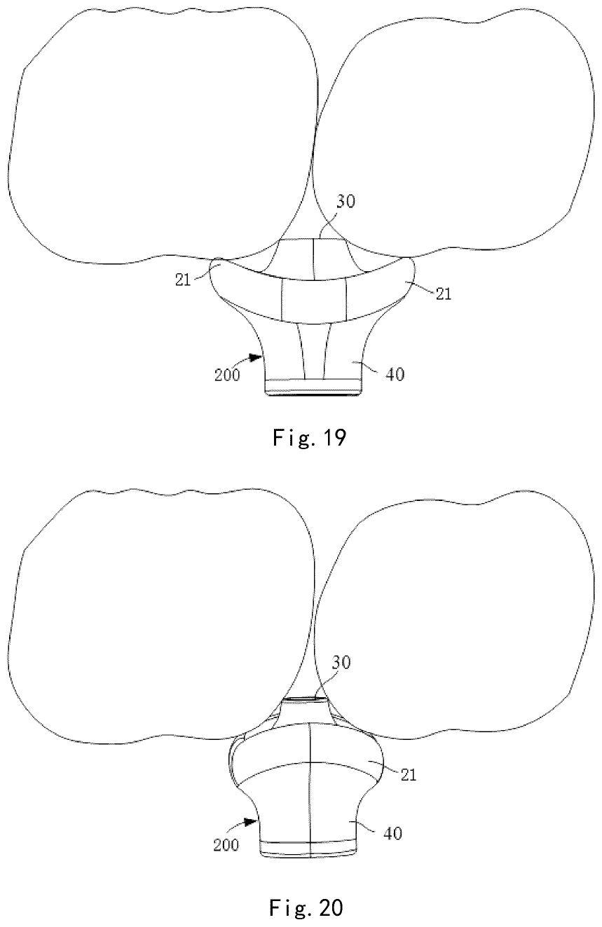

It should be noted that, referring to FIGS. 19 and 20, when the nozzle 200 cleans the oral cavity, the nozzle 200 may be arranged between two adjacent teeth in the oral cavity, so as to spray water to the tooth slit between the two adjacent teeth through the nozzle 200, thereby achieving a cleaning effect. Referring to FIG. 24, The limiting portion 21 of the nozzle 200 can abut against a tooth surface of one of two adjacent teeth; and referring to FIG. 10, the limiting portion 21 can also simultaneously abut against tooth faces of two adjacent teeth, which is not limited.

With continued reference to FIGS. 16-18, in the direction from one end of the limiting portion 21 connected to the connecting sleeve 40 to the other end thereof, the thickness of the limiting portion 21 in the liquid flow direction x is gradually reduced, so that the limiting portion 21 is deformed away from the end of the connecting sleeve 40 to adapt to more types of teeth; and the thickness of the limiting portion 21 is smoothly deformed, so that the limiting portion 21 is prevented from aging and cracking, and the service life is improved.

In the direction from one end of the limiting portion 21 connected to the connecting sleeve 40 to the other end thereof, the abutting surface 1201 of the limiting portion 21 close to the deformation portion 20 bulges in the direction away from the deformation portion 20. It can be understood that the section of the limiting portion 21 in the first plane is arc-shaped, in which the first plane is parallel to the axial direction of the second flow channel 1010 and parallel to the extending direction of the limiting portion 21. Thus, the abutting surface 1201 of the limiting portion 21 can conform to the shape of the teeth, and the positioning is stable. Certainly, in the direction from one end of the limiting portion 21 connected to the connecting sleeve 40 to the other end thereof, the abutting surface 1201 of the limiting portion 21 may also be smooth, and may be flexibly designed according to actual requirements.

From the circumferential direction of the second flow channel 1010, the abutting surface 1201 of the limiting portion 21 bulges in the direction away from the deformation portion 20. It can be understood that the section of the limiting portion 21 in the second plane is arc-shaped, wherein the second plane is parallel to the axial direction of the second flow channel 1010 and perpendicular to the extending direction of the limiting portion 21. Certainly, from the circumferential direction of the second flow channel 1010, the abutting face 1201 of the limiting portion 21 may also be smooth, may be designed flexibly in combination with practical requirements.

Along the liquid flow direction x, at least part of the deformation portion 20 is located downstream of the end of the limiting portion 21 remote from the connection sleeve 40. That is, the height of the limiting portion 21 protruding in the liquid flow direction x does not exceed the deformation portion 20. In this way, when the user's oral cavity is cleaned, the deformation portion 20 is closer to the teeth compared with the free end 21. The deformation portion 20 may be disposed at the teeth slit between two teeth first, which helps improving the positioning speed of the nozzle 200 at the teeth slit. Furthermore, since the teeth slit is provided with a concave portion, the deformation portion 20 disposed in the concave portion is not easy to slide out, which is good for improving the positioning stability of the nozzle 200 at the teeth slit.

It should be noted that, if the nozzle 200 includes the soft flange 30, along the flow direction x of the liquid, it can be designed that at least a part of the deformation portion 20 is located downstream of the end of the limiting portion 21 away from the connecting sleeve 40, It can also be designed that at least a part of the soft flange 30 is located downstream of the end of the limiting portion 21 away from the connecting sleeve 40, Both ways can achieve that the soft flange 30 is closer to the teeth than the limiting portion 21, so that the soft flange 30 can be positioned at the slit between two teeth first, increasing the positioning speed and positioning stability of the nozzle 200 at the tooth slit.

After the soft flange 30 is disposed at the teeth slit, the limiting portion 21 will be in contact with teeth, which can further improve the positioning stability of the nozzle 200 at the teeth slit, so that the water outlet direction of the nozzle 200 is stable, and the teeth slit can be washed steadily, improving the cleaning effect. Since the soft flange 30 can generate a certain deformation according to the recess depth of teeth slit, for different recess depths, the limiting portion 21 can be ensured to be in contact with teeth, thereby improving the usage range of the nozzle 200.

It should be noted that in a direction away from the connecting sleeve 40, the limiting portion 21 extends obliquely towards the direction near deformation portion 20, which not only facilitates the contact between the limiting portion 21 and the teeth, but also serves the function of blocking the fluid ejected from the nozzle 200, so as to reduce the sputtering out of the mouth after the fluid is flushed to the tooth surface.

It should be noted that, in the embodiments of the present disclosure, when in use, the nozzle 200 may contact teeth with the limiting portion 21 only, and may also contact teeth with both the limiting portion 21 and the soft flange 30, which is not limited thereto.

As shown in FIG. 18, if the imaginary surface defined perpendicular to the fluid flow direction x and passing through the end of the limiting portion 21 at the end facing away from the connecting sleeve 40 is defined as a third reference surface s, the distance h₃ from the end of the soft flange 30 facing away from the deformation portion 20 to the third reference surface s along the fluid flow direction x is greater than or equal to 0.1 mm and less than or equal to 1.5 mm. By reasonably defining the dimension h₃ of the soft flange 30 protruding from the limiting portion 21 in the liquid flow direction x, it is more beneficial for the soft flange 30 to extend into the teeth slit between two adjacent teeth. Since the depth of the teeth slit is relatively limited, if h₃ is greater than 1.5 mm, there may exist the problem that the limiting portion 21 cannot contact teeth; If h₃ is less than 0.1 mm, the limiting portion 21 may come into contact with the tooth before the soft flange 30, which is adverse to the positioning of the soft flange 30 at the teeth slit.

It should be noted that, along the liquid flow direction x, the distance h₃ from the end of the soft flange 30 away from the deformation portion 20 to the third reference surface s refers to the distance from the point of the soft flange 30 away from the third reference surface s to the third reference surface s along the liquid flow direction x.

Therein, h₃ may specifically be 0.1 mm, 0.5 mm, 0.8 mm, 1.0 mm, 1.2 mm, 1.5 mm, and the like, which is not limited herein.

The distance h₄ from the end of the soft flange 30 facing away from the deformation portion 20 to where the connecting sleeve 40 connects to the limiting portion 21 along the fluid flow direction x is greater than or equal to 0.5 mm and less than or equal to 3 mm. By reasonably defining h₄, it is more beneficial for the outlet end 30 of the soft flange 30 to extend into the teeth slit between two adjacent teeth. Since the depth of the teeth slit is relatively limited, if h₄ is greater than 3 mm, there may exist the problem that the soft flange 30 cannot contact teeth; If h₄ is less than 0.5 mm, the limiting portion 21 may come into contact with the tooth before the soft flange 30, which is adverse to the positioning of the soft flange 30 at the teeth slit.

It should be noted that, the distance h₄ from the end of the soft flange 30 facing away from the deformation portion 20 to where the connecting sleeve 40 connects to the limiting portion 21 along the fluid flow direction x refers to the distance along the liquid flow direction x from the end of the soft flange 30 away from the deformation portion 20 to a point of the connecting interface between the connecting sleeve 40 and the limiting portion 21 closest to the soft flange 30.

Therein, h₄ may specifically be 0.5 mm, 0.8 mm, 1 mm, 1.5 mm, 2 mm, 2.5 mm, 3 mm, and the like, which is not limited herein.

If the imaginary surface defined perpendicular to the fluid flow direction x and passing through the end of the limiting portion 21 at the end facing away from the connecting sleeve 40 is defined as a third reference surface s, the angle between the water outflow direction of the nozzle 200 and the third reference surface s is greater than or equal to 80 degrees and less than or equal to 100 degrees. In this way, when the limiting portion 21 contacts the teeth, the water outlet direction of the nozzle 200 can be roughly aligned with the tooth slit, avoiding that the water outlet direction of the nozzle 200 is inclined to impact the teeth surfaces, the flushing effect of the fluid returns backward after the tooth surface collision becomes weaker, the cleaning effect becomes poor, and the fluid returns backwards easily impacts the gums, resulting in bleeding of gums.

Wherein, the angle between the water outflow direction of the nozzle 200 and the third reference surface s may specifically be 80 degrees, 85 degrees, 90 degrees, 95 degrees, 100 degrees, or the like, which is not limited herein.

In the embodiment of the present disclosure, the nozzle 200 may include one limiting portion 21, and may also include a plurality of limiting portions 21. If the nozzle 200 includes one limiting portion 21, the limiting portion 21 may be in an annular shape wound around the periphery of the connecting sleeve 40, or may not be in an annular shape wound around the periphery of the connecting sleeve 40. If the nozzle 200 comprises a plurality of limiting portions 21, the ends of the plurality of abutting parts 21 far away from the connecting sleeve 40 can be arranged at intervals on the periphery of the connecting sleeve 40, such that the end of each limiting portion 21 far away from the connecting sleeve 40 are independent relative to each other, and their contact with the teeth will not affect each other, which facilitates each limiting portion 21 to deform correspondingly in the shape of the tooth face corresponding to the teeth, thereby improving the stability of contact between the nozzle 200 and the teeth.

If the nozzle 200 comprises a plurality of limiting portions 21, one end of at least one of the limiting portions 21 facing away from the connecting sleeve 40 is located within the third reference plane s, or one end of the plurality of limiting portions 21 facing away from the connecting sleeve 40 is substantially evenly distributed on two opposite sides of the third reference plane s.

Please refer to FIG. 21, if the nozzle 200 comprises a plurality of limiting portions 21, the soft flange 30 may comprise a plurality of notches 32, and each notch 32 is disposed corresponding to one of the limiting portions 21 in the direction perpendicular to the flow direction x of the liquid. It should be understood that the direction perpendicular to the liquid flow direction x can be a plurality of directions, and the notches 32 correspond to a plurality of directions perpendicular to the liquid flow direction x, the direction corresponding to the limiting portion 21 allows the fluid exiting through the notch 32 may be blocked by the corresponding limiting portion 21, thereby preventing the fluid from splashing.

In the embodiment of the present disclosure, the nozzle 200 comprises two limiting portions 21, and the two limiting portions 21 are located on opposite sides of the nozzle 200 perpendicular to the liquid flow direction x, so that the structure of the nozzle 200 is simple, and the positioning stability between the nozzle 200 and teeth is better.

The limiting portion 21 may be made of a soft material component only at the end away from the connecting sleeve 40, or may be made of a soft material component as a whole. The soft material component is elastic, and the limiting portion 21 as a whole, or the end away from the connecting sleeve 40 is a soft material component, which can adapt to teeth of different sizes and shapes, thereby improving the usage range of the nozzle 200.

It should be noted that the limiting portion 21 as a whole, or the end away from the connecting sleeve 40 is a soft material component, and can also damp vibration transmitted to teeth when the nozzle 200 is used, thereby improving the user experience.

In the embodiment of the present disclosure, the soft material component of the nozzle 200 may be made of a material such as soft rubber, the soft material components at different positions can be made of the same material, or may be made of different materials, which is not limited herein.

In the embodiment of the present disclosure, the jet tube 101A is a hard material component. The hard material component refers to a material component which is unlikely to be deformed when subjected to a general acting force (for example, an acting force applied to the nozzle 200 when a user uses the nozzle 200), so that the jet tube 101A can play a better supporting effect on the deformation portion 20, and the nozzle 200 is prevented from being blocked due to serious extrusion deformation of the deformation portion 20.

It should be noted that the structure of the nozzle 200 other than the jet tube 101A may be an integrally formed structure, so that the nozzle 200 has good structural stability.

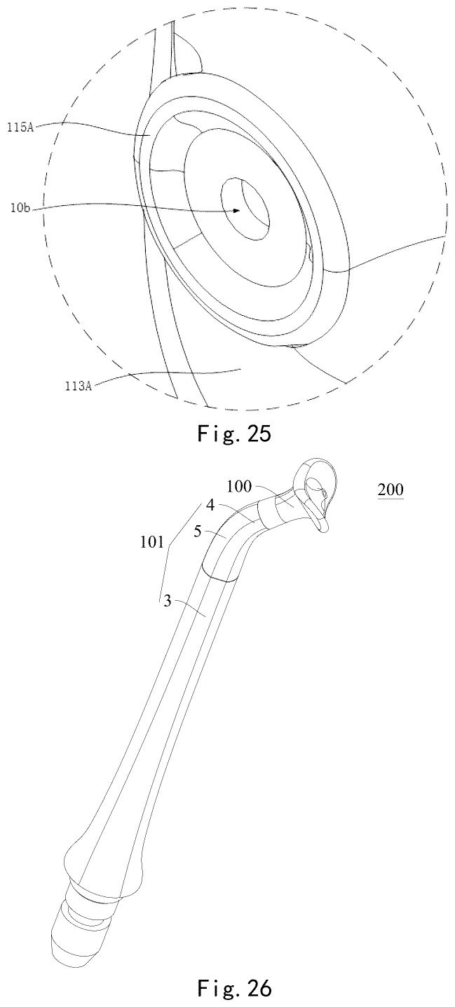

In some embodiments, as shown in FIGS. 22-25, the spray head 100 is configured as a soft rubber head 11, the spray rod 101 is configured as a hard effuser 12 which is rigid, one end of the hard effuser 12 away from the soft rubber head 11 is connected to the body of irrigator, the soft rubber head 11 has a first flow channel 10, and the first flow channel 10 forms a water outlet 10b on the surface of the soft rubber head 11; the hard effuser 12 comprises an embedded section 121b embedded in the soft rubber head 11, at least the hardness of the embedded section 121b is greater than the hardness of the soft rubber head 11, and a fourth flow channel 121A in communication with the first flow channel 10 is provided in the embedded section 121b; Wherein, along the embedding direction X of the embedding section 121b embedded into the soft rubber head 11, the soft rubber head 11 has a first length L1, the length of the embedding section 121b is a second length L2, and the ratio of the second length L2 to the first length L1 is greater than 1/2.

In the embodiments of the present disclosure, the embedded section 121b of the hard effuser 12 is embedded in the soft rubber head 11, so that the embedded section 121b can support the soft rubber head 11 in the soft rubber head 11, thereby reducing the probability of deformation of the soft rubber head 11, reducing the probability of blockage after the soft rubber head 11 deforms from the water outlet 10b, and facilitating users in cleaning an oral cavity using an oral irrigator. Further, the deformation probability of the soft rubber head 11 can be further reduced because the hardness of the embedded section 121b is greater than the hardness of the soft rubber head 11. Furthermore, a ratio of the second length L2 to the first length L1 is greater than 1/2, so that the length of the embedded section 121b is relatively long, thereby reducing the probability of deformation of the soft rubber head 11, and further reducing the probability of blockage of the soft rubber head 11 from the water outlet 10b, so that a user can clean the oral cavity using an oral irrigator. If the ratio of the second length L2 to the first length L1 is less than or equal to 1/2, the embedded section 121b may have a short length, resulting in that the embedded section 121b has a poor support for the water outlet 10b, resulting in a high probability of blockage after the water outlet 10b of the soft rubber head 11 deforming, and causing inconvenience for the user to clean the oral cavity by using the oral irrigator.

In some embodiments, the embedded section 121b may define at least a portion of the water outlet section 113a of the second flow channel 1010 described above in this disclosure.

Exemplarily, the soft rubber head 11 may be made of silica gel, polyester rubber, or latex. Exemplarily, the soft rubber head 11 may be made of silica gel. Due to the stable chemical properties of the silica gel, the soft rubber head 11 can be used more safely. Exemplarily, the hard effuser 12 may be made of at least one of the copolymer of polyethylene terephthalate/cyclohexane dimethanol (PCTG) and polycarbonate (PC) as an amorphous copolyester, polyethylene terephthalate (PET), high density polyethylene (HDPE), low density polyethylene (LDPE), polypropylene (PP), polystyrene (PS), and polycarbonate (PC).

It should be understood that, in other embodiments, the Overall hardness of the hard effuser 12 may be greater than the hardness of the soft rubber head 11, thereby improving the stability of the connection between the hard effuser 12 and the soft rubber head 11.

It can be understood that, the embedding direction X may be at least one of a straight line and a curved line, and in the implementation of the present disclosure, the embedding direction X is not specifically limited.

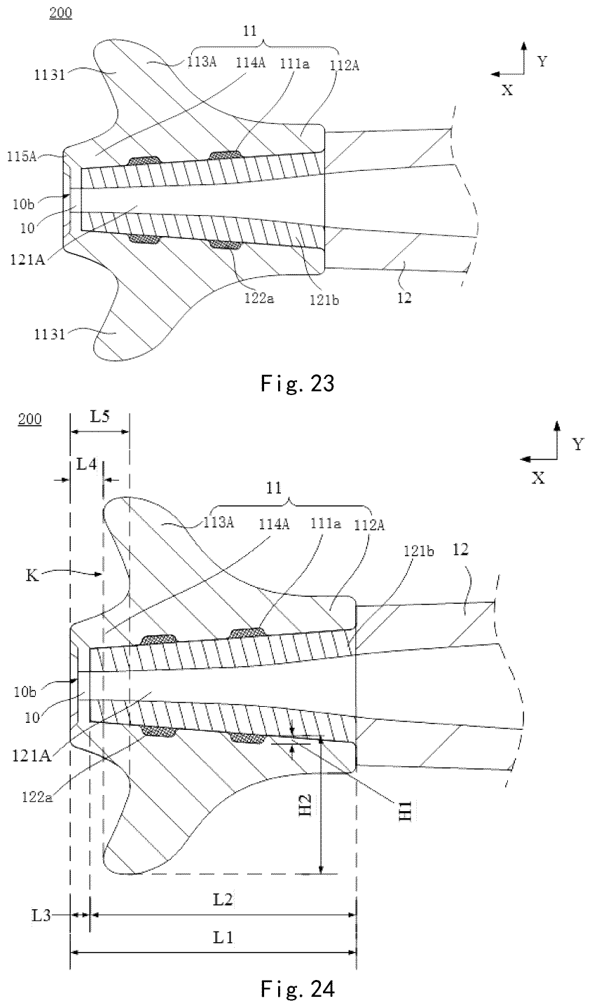

Please refer to FIGS. 22 and 23, in some specific embodiments, the embedded section 121b is connected to the soft rubber head 11, and the embedded section 121b and the soft rubber head 11 may be formed integrally or formed separately. Exemplarily, the embedded section 121b and the soft rubber head 11 may be processed separately, and then the soft rubber head 11 and the embedded section 121b are assembled, so that the embedded section 121b is connected to the soft rubber head 11, and the soft rubber head 11 can be replaced separately, thereby reducing replacement costs. Exemplarily, the soft rubber head 11 may be integrally formed on the embedded section 121b, so as to improve the connection tightness between the soft rubber head 11 and the embedded section 121b, and improve the connection stability between the soft rubber head 11 and the embedded section 121b, thereby preventing the soft rubber head 11 from falling off the embedded section 121b.

Referring to FIGS. 22-24, in some embodiments, the first flow channel 10 has a third length L3 along the embedding direction X, the third length L3 being greater than or equal to 0.5 mm and less than or equal to 5 mm, which makes the length of the first flow channel 10 shorter, so that structural strength of the first flow channel 10 is high, the probability of deformation of the first flow channel 10 is low, thus, the water outlet 10b can be ensured to smoothly discharge water, so as to clean the oral cavity of users. Furthermore, because the third length L3 is smaller than or equal to 5 mm, the distance between the water outlet 10b and the embedded section 121b is relatively short, so that the deformation probability of the water outlet 10b is low, and the blockage probability of the water outlet 10b due to the deformation is low, thus, it is convenient to clean the oral cavity by using the oral irrigator, and at the same time, the third length L3 is greater than or equal to 0.5 mm, so that a thick soft rubber head 11 is provided between the hard effuser 12 and the water outlet 10b, so that the soft rubber head 11 is not easily broken, the soft rubber head 11 can be used to protect the hard effuser 12, and the soft rubber head 11 can also be used to protect the oral cavity, exemplarily, when the end of the soft rubber head 11 close to the water outlet 10b abuts against the oral cavity, the thick soft rubber head 11 can buffer the movement of the hard effuser 12, to reduce the probability that the hard effuser 12 damages the oral cavity. If the third length L3 is greater than 5 mm, the length of the first flow channel 10 is long, which results in a low structural strength of the first flow channel 10, results in a high probability of deformation of the first flow channel 10, results in a high probability of deformation of the water outlet 10b, and results in easy blockage of the water outlet 10b, thereby causing inconvenience for users to clean the oral cavity by using a oral irrigator. If the third length L3 is less than 0.5 mm, the soft rubber head 11 between the hard effuser 12 and the water outlet 10b will be thin, and the soft rubber head 11 between the hard effuser 12 and the water outlet 10b is easy to break, affecting the service life of the soft rubber head 11; Furthermore, because the soft rubber head 11 between the hard effuser 12 and the water outlet 10b is thin, the soft rubber head 11 between the hard effuser 12 and the water outlet 10b has a poor damping effect, and thus the hard effuser 12 has a high probability of damaging the oral cavity. Exemplarily, the third length L3 may be 0.5 mm, 1 mm, 2 mm, 3 mm, or 5 mm.

Please refer to FIGS. 22 and 23, in some specific embodiments, the first flow channel 10 has a first flow cross-section perpendicular to the embedding direction X, the fourth flow channel 121A has a second flow cross-section perpendicular to the insertion direction X, and along the insertion direction X, the area of the first flow cross-section and the area of the second flow cross-section gradually decrease, so that the flow rate of the liquid in the first flow channel 10 and the fourth flow channel 121A is gradually increased, so that the liquid flow rate at the water outlet 10b is faster, further, impurities in the oral cavity of the user can be cleaned well.

Please refer to FIGS. 22 and 23, in some specific embodiments, along the embedding direction X, the inner surface of the fourth flow channel 121A is too smooth with the inner surface of the first flow channel 10, in this way, a resistance of the fluid flowing through a joint between the fourth flow channel 121A and the first flow channel 10 may be reduced, thereby facilitating the fluid to flow in the first flow channel 10 and the fourth flow channel 121A. In this way, ensuring that when the fluid is ejected from the water outlet 10b, there is still a high speed, and thus the oral cavity of the user can be cleaned.

Please refer to FIGS. 22 and 23, in some specific embodiments, the embedded section 121b has a plurality of third connecting portions 122a embedded in the soft rubber head 11 and spaced apart from each other, the soft rubber head 11 has a plurality of fourth connecting portions 111a which are spaced apart from each other, and the third connecting portion 122a are correspondingly clamped with the fourth connecting portion 111a one by one, So that the contact area between the embedded section 121b and the soft rubber head 11 can be increased, thereby improving the tightness of the connection between the embedded section 121b and the soft rubber head 11, so that the connection stability between the hard effuser 12 and the soft rubber head 11 is improved. Exemplarily, the number of the third connecting portions 122a and the number of the fourth connecting portions 111a may be two respectively, the two third connecting portions 122a are spaced apart from each other, and the two fourth connecting portions 111a are spaced apart from each other. Exemplarily, the number of the third connecting portions 122a and the number of the fourth connecting portions 111a may be four respectively, two adjacent third connecting portions 122a are spaced apart, and two adjacent fourth connecting portions 111a are spaced apart. In the embodiment of the present disclosure, the number of the third connection portion 122a and the number of the fourth connection portion 111a are not specifically limited.

Please refer to FIGS. 22 and 23, in some specific embodiments, one of the third connection portion 122a and the fourth connection portion 111a is a protrusion, the other of the third connecting portion 122a and the fourth connecting portion 111a is a groove, and the protrusion is snap-fitted in the groove, so that the contact area between the embedded section 121b and the soft rubber head 11 can be increased, thereby improving the tightness of the connection between the embedded section 121b and the soft rubber head 11, so that the connection stability between the hard effuser 12 and the soft rubber head 11 is improved.

Please refer to FIGS. 22 and 24, as an example, the third connecting portion 122a is a protrusion, the fourth connecting portion 111a is a groove, the protrusion has a first height H1 along the protrusion direction Y, the protrusion direction Y is perpendicular to the embedding direction X, and the first height H1 is greater than or equal to 0.1 mm, so that the protrusion and the groove have a larger clamping area, so that the connection between the protrusion and the groove is stable, Thus, the stability of the connection between the hard effuser 12 and the soft rubber head 11 can be increased; Furthermore, because the first height H1 is high, the probability that the protrusion gets out of the groove can be low, thereby further improving the connection stability between the hard effuser 12 and the soft rubber head 11. If the first height H1 is smaller than 0.1 mm, the protruding height of the protrusion along the protruding direction Y will be smaller, which leads the contact area between the protrusion and the groove be smaller, as a result, the stability of the connection between the hard effuser 12 and the soft rubber head 11 is poor, and the first height H1 is small, When the soft rubber head 11 is subjected to a large force along the embedding direction X, the soft rubber head 11 easily detaches from the hard effuser 12, which results in poor connection stability between the hard effuser 12 and the soft rubber head 11. Illustratively, the first height H1 may be 0.1 mm, 0.2 mm, or 0.3 mm.

Please refer to FIGS. 22 and 23, in some specific embodiments, at least a portion of the spray head main body 1 is configured to be a main body part 112A, the stopping structure 2 is configured to be a wing part 113A, and the soft rubber head 11 comprises a main body part 112A, a wing part 113A and a convex part protruding portion 114A, wherein the wing part 113A is provided on the peripheral side of the main body part 112A and extends in a direction away from the main body part 112A; the protruding portion 114A is connected to one end of the main body part 112A and extends along the embedding direction X, the protruding portion 114A is protruded relative to the wing part 113A, and the water outlet 10b is located at one end of the protruding portion 114A away from the main body part 112A; The embedded section 121b is embedded in the main body part 112A and the protruding portion 114A. Exemplarily, when a user cleans teeth by using a oral irrigator, the wing part 113A may abut against the tooth circumferential faces of teeth on two sides of a slit, so that the water outlet 10b is aligned with the slit, or the wing part 113A abuts against the gums, so that the water outlet 10b is aligned with the slit or the teeth, Thus, the liquid sprayed from the water outlet 10b can be used to clean the teeth, thereby preventing the water outlet 10b from directly contacting the teeth, in order to prevent the teeth from blocking the water outlet 10b and prevent the impurity from blocking the water outlet 10b, the blocking probability of the water outlet 10b can be reduced, so as to ensure that the fluid ejected from the water outlet 10b can clean the teeth of user.

In some embodiments, the protruding portion 114A may be configured as at least part of the protruding portion 112 described above herein.

Please refer to FIG. 24, in some specific embodiments, the wing part 113A has a reference plane K perpendicular to the embedding direction X, the vertex of the wing part 113A along the embedding direction X is located within the reference plane K, and the protruding portion 114A extends from the main body part 112A along the embedding direction X and passes through the reference plane K, and the liquid spraying direction of the water outlet 10b is perpendicular to the reference plane K, so that when the wing part 113A abuts against the peripheral surface of teeth or gums, the liquid spraying direction of the water outlet 10b may be perpendicular to or substantially perpendicular to the teeth, so that the water flow can direct to the teeth slit, thus, the teeth or the teeth slit of the user can be cleaned well, so as to improve the cleaning effect of the oral irrigator.

Please refer to FIG. 24, in some specific embodiments, along the embedding direction X, the protruding portion 114A protrudes beyond the reference plane K by a fourth length LA, The fourth length LA is greater than or equal to 0.1 mm, so that the protruding length of the protruding portion 114A is longer than that of the reference plane K, so that the water outlet 10b can be closer to the slit or the teeth when the wing part 113A abuts against the circumference surface or the gum, the cleaning effect of the liquid ejected from the water outlet 10b on the oral cavity can be improved.

If the fourth length L4 is smaller than 0.1 mm, the protruding length of the protruding portion 114A is shorter than that of the reference plane K. When the wing part 113A abuts against the peripheral surface of the teeth or the gums, the distance between the water outlet 10b and the teeth or the slit is larger, and the cleaning effect of the liquid ejected from the water outlet 10b on the teeth or the slit is poor. Illustratively, the fourth length LA may be 0.1 mm, 0.2 mm, or 0.3 mm.

Please refer to FIG. 23, in some specific embodiments, the protruding portion 114A has a third cross-section perpendicular to the embedding direction X, and along the embedding direction X, the area of the third cross-section gradually decreases, so that the liquid flow rate of the water outlet 10b can be further increased, thereby improving the cleaning effect of the dental padder on the oral cavity.

Please refer to FIG. 23, in some specific embodiments, along the embedding direction X, the extension direction of the wing part 113A relative to the main body part 112A has a first component parallel to the embedding direction X, and a second component perpendicular to the embedding direction X, which can increase the structural strength of the wing part 113A, so that when the wing part 113 A abuts against a peripheral teeth surface or gum, The deformation of the wing part 113A can be reduced, so as to ensure that the wing part 113A can support the soft rubber head 11, so as to increase the stability of the connection between the soft rubber head 11 and the oral cavity.

Please refer to FIG. 24, for example, the protruding portion 114A has a fifth length L5 relative to the joint between the wing part 113A and the main body part 112A, the fifth length L5 is greater than or equal to 0.5 mm and less than or equal to 3 mm, such that the protruding portion 114A may abut against the peripheral surface of the tooth or the gum on the wing part 113A, the water outlet 10b can be spaced from the teeth, and the water outlet 10b is close to the teeth or the teeth slit, thus, the effect of cleaning teeth or teeth slit can be improved. If the fifth length L5 is smaller than 0.5 mm, when the wing part 113A abuts against the circumference surface or the gum, the water outlet 10b is far away from the teeth or the gums, resulting in a poor cleaning effect for the teeth or the slit. If the fifth length L5 is greater than 3 mm, when the wing part 113A abuts against the circumference surface or the gum of the tooth, the water outlet 10b abuts against the tooth, which affects water spraying from the water outlet 10b, and results in a poor cleaning effect on the tooth. Exemplarily, the fifth length L5 may be 0.5 mm, 1 mm, 2 mm, or 3 mm.

Please refer to FIG. 24, in some specific embodiments, the wing part 113A has a fourth cross-section parallel to the embedding direction X, the area of the fourth cross-section gradually decreases in a direction away from the main body part 112A, so that the side of the wing part 113A away from the main body part 112A is in contact with teeth or gums, deformation will easily occur, so that the teeth and gums of the user can be protected to prevent the soft rubber head 11 from damaging the teeth or gums of the user.

Please refer to FIG. 24, in some specific embodiments, the wing part 113A have a second height H2 along the protruding direction Y, the second height H2 is equal to or larger than 1.5 mm and equal to or smaller than 4 mm so that the wing part 113A may have a high structural strength, and the side of the wing part 113A away from the main body part 112A is easily deformed, so as to facilitate absorbing the vibration transmitted to the soft rubber head 11 by the oral irrigator, or can absorb the impact force of the soft rubber head 11 on the teeth or gums, so as to protect the teeth and gums of the user. If the second height H2 is smaller than 1.5 mm, as the second height H2 is smaller, the side of the wing part 113A away from the main body part 112A is not likely to be deformed, and it is not good for absorbing the vibration transmitted to the soft rubber head 11 by the oral irrigator, or it is not good for absorbing the impact force of the soft rubber head 11 on teeth or gums, and it is easy to cause damage to teeth or gums of a user. If the second height H2 is greater than 4 mm, because the wing part 113A is long, the stability of the connection between the wing part 113A and the main body part 112A is poor; and because the wing part 113A is long, the side of the wing part 113A away from the main body part 112A is likely to generate a large deformation, and the water outlet 10b is likely to abut against the teeth, which affects the water outlet 10b spraying, and results in a poor cleaning effect on the teeth or the teeth slit. Exemplarily, the second length H2 may be 1.5 mm, 2 mm, 3 mm, or 4 mm.

Please refer to FIG. 23, in some specific embodiments, the wing part 113A includes two fender part 1131 spaced apart, the two fender part 1131 are symmetrically disposed on two sides of the main body part 112A with respect to the midline of the water outlet 10b, so that the contact area between the wing part 113A and teeth or gums can be increased, so as to increase the stability of the connection between the wing part 113A and the teeth or gums, and further increase the stability of the connection between the soft rubber head 11 and the teeth or gums, thus, the cleaning effect of the oral irrigator on the oral cavity of the user is improved.

In some embodiments, the fender part 1131 may be configured as the limiting portion 21 described above in this application.

It should be understood that, in some other specific embodiments, the wing part 113A is an annular wing part 113A, and the annular wing part 113A is annularly disposed on a peripheral side of the main body part 112A, so that the annular wing part 113A can abut against at least one of the teeth and the gums, so as to increase the stability of the connection between the wing part 113A and the teeth and the gums, so that the impactor can clean the oral cavity of the user.

Please refer to FIGS. 22 to 25, in some specific embodiments, the soft rubber head 11 further includes a flange part 115A, and the flange part 115A is disposed at one end of the protruding portion 114A away from the main body part 112A, and enclosing the peripheral side of the water outlet 10b, wherein when the teeth are cleaned by using an oral irrigator, the wing part 113A can abut against one of the teeth and the gums, and the flange part 115A abuts against the teeth, which can increase the contact area between the soft rubber head 11 and the oral cavity, so as to increase the stability of the connection between the soft rubber head 11 and the oral cavity, and since the flange part 115A surrounds the peripheral side of the water outlet 10b, even when the flange part 115A contacts the teeth, the water outlet 10b can still spray liquid, thereby preventing the teeth from blocking spraying from the water outlet 10b, In order to improve the cleaning effect of the oral irrigator, furthermore, since the flange part 115A surrounds the peripheral side of the water outlet 10b, thus, the liquid is prevented from splashing around the water outlet 10b, so as to prevent the clothes or skin of the user from being polluted.

In some embodiments, the flange part 115A may be configured as a portion of the protruding portion 112 described above herein; Alternatively, the flange part 115A may be configured as a soft flange 30.

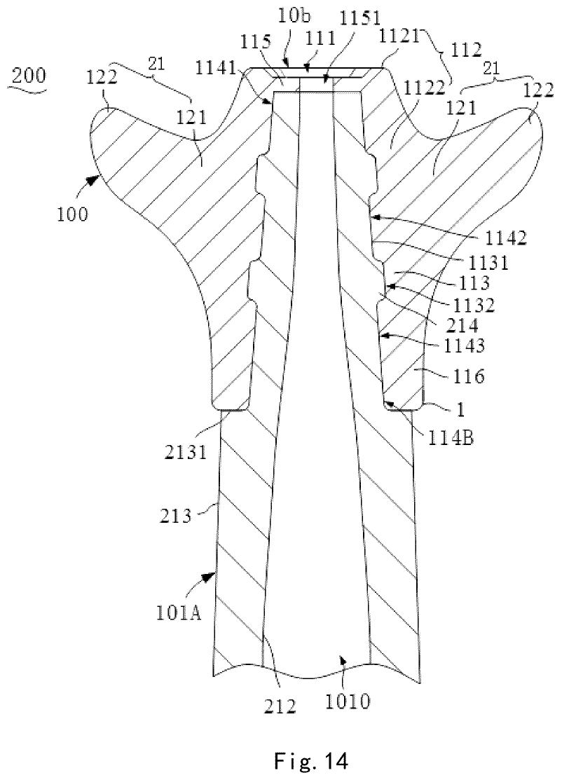

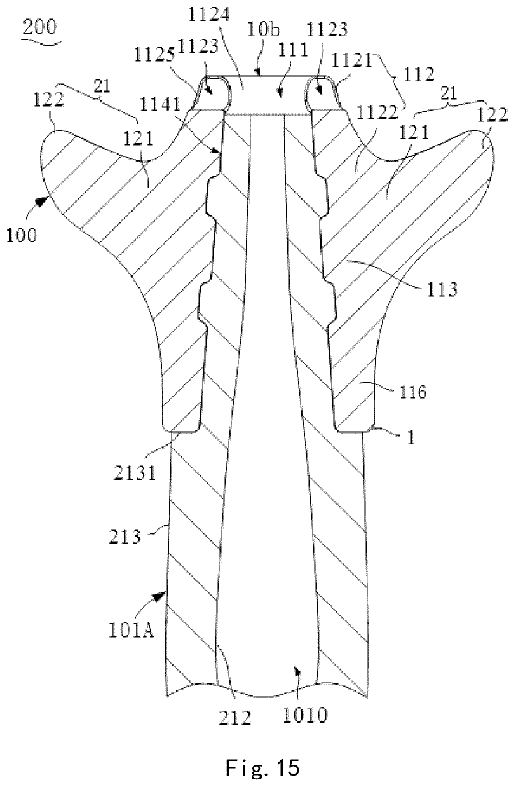

In some embodiments, as shown in FIGS. 14 and 15, the spray rod 101 is configured as a jet tube 101A, the spray head main body 1 is further provided with a mounting groove 114B, and the jet tube 101A is located in the mounting groove 114B. The mounting groove 114B facilitates the assembly and positioning between the spray head 100 and the jet tube 101A and improves the reliability of the connection therebetween. Specifically, a portion of the jet tube 101A may be inserted into the mounting groove 114B of the spray head 100 to improve the connection stability between the jet tube 101A and the spray head 100.

In some embodiments, the fitting of the jet tube 101A is configured to facilitate the mounting of the slot 114B may be configured as an embedded section 121b.

Further, as shown in FIGS. 14 and 15, the spray head main body 1 comprises a protruding portion 112 and a first connecting portion 113, the protruding portion 112 forms at least a portion of the first flow channel 10, and the protruding portion 112 has a water outlet end 1121 corresponding to the water outlet 10b and a first end 1122 opposite to the water outlet end 1121; the first connecting portion 113 is connected to the first end 1122 of the protruding portion 112, and the connecting end 121 of the limiting portion 21 is connected to the first connecting portion 113; In this case, the mounting groove 114B is located at a side of the spray head main body 1 away from the water outlet end 1121, the bottom wall of the mounting groove 114B may extend to the first connecting part 113, and the bottom wall of the mounting groove 114B may also extend to the protruding portion 112. The bottom wall of the mounting groove 114B is a wall of the inner wall of the mounting groove 114B opposite to the water outlet end 1121.

When the bottom wall of the mounting groove 114B extends to the protruding portion 112, the mounting groove 114B comprises a first sub-groove 1141 and a second sub-groove 1142, The first end 1122 of the protruding portion 112 forms a first sub-groove 1141, and the water outlet end 1121 of the protruding portion 112 forms a first flow channel 10, the first connecting part 113 forms a second sub-groove 1142, the second sub-groove 1142 is in communication with the first sub-groove 1141, and the jet tube 101A extends into the first sub-groove 1141 and the second sub-groove 1142 and is fitted and connected to the first sub-groove 1141 and the second sub-groove 1142, The contact area between the jet tube 101A and the spray head 100 is strengthened, and the stability of the connection therebetween is improved. Furthermore, the jet tube 101A extends into the first sub-groove 1141 formed on the protruding portion 112 to provide a certain support effect for the protrusion part 112.

The jet tube 101A may be a hard material member, and the hard material member refers to a material member which is unlikely to be deformed when subjected to a general acting force (for example, an acting force applied to the spray head 100 when a user uses the spray head 100), so that the jet tube 101A may provide a better supporting effect for the spray head 100.

When the bottom wall of the mounting groove 114B extends to the protruding portion 112, that is, when the protruding portion 112 is formed with the first sub-groove 1141, the jet tube 101A of the rigid material member extends into the first sub-groove 1141, so as to provide a supporting effect for the protruding portion 112, and prevent the protruding portion 112 from being severely pressed and deformed when the protruding portion 112 is placed at a slit, thereby preventing the water outlet 10b from being blocked.

In some embodiments, as shown in FIGS. 14 and 15, the spray head main body 1 further comprises a second connecting portion 116 connected to an end of the first connecting portion 113 away from the protruding portion 112. The arrangement of the second connecting part 116 can increase the length of the spray head main body 1 in the axial direction x of the first flow channel 10, thereby improving the structural stability of the spray head main body 1. The mounting groove 114B comprises a third sub-groove 1143, the second connecting part 116 forms a third sub-groove 1143, and the jet tube 101A further extends into the third sub-groove 1143 and is fitted and connected to the third sub-groove 1143, so that the connection reliability between the jet tube 101A and the spray head 100 can be further improved.

In some embodiments, as shown in FIGS. 14 and 15, the mounting groove 114B is provided with a second limiting protrusion protruding from an inner wall of the mounting groove 114B, the jet tube 101A is provided with a second position-limiting groove corresponding to the second limiting protrusion of the spray head 100, and/or the mounting groove is provided with a second position-limiting groove 1132, The second position-limiting groove 1132 is recessed with respect to the inner wall of the mounting groove 114B, and the jet tube 101A is provided with a second position-limiting protrusion 214 corresponding to the second position-limiting groove 1132 of the spray head 100, The second limiting protrusion is located in the corresponding second position-limiting groove. The provision of the second limiting protrusion and the second position-limiting groove enables the depth of the jet tube 101A extending into the mounting groove 114B to be limited between the jet tube 101A and the spray head 100 by means of the second position-limiting protrusion and the second position-limiting groove, thereby improving the assembly positioning precision of the jet tube 101A and the spray head 100.

The inner wall of the mounting groove 114B includes a bottom wall and a circumferential wall. The bottom wall is disposed opposite to the water outlet end 1121, and the circumferential wall is disposed around the circumferential direction z of the first flow channel 10. In the embodiment of the present disclosure, the second limiting protrusion and the second limiting groove on the mounting groove 114B may be provided on a bottom wall and/or a peripheral wall thereof.

It should be noted that the second limiting protrusion and the second position-limiting groove may be provided on at least one of the protruding portion 112, the first connecting portion 113 and the second connecting part 116, which is not limited herein.

The second limiting protrusion may be in an annular shape and is arranged around a circumference z of the first flow channel 10, which is not limited herein.

In some embodiments, as shown in FIG. 9, the spray head main body 1 further comprises a buffer part 115, the buffer part 115 is located in the first flow channel 10 and separates the mounting groove 114B from the first flow channel 10, the buffer part 115 is connected to the protruding portion 112 and protrudes from the protruding portion 112, and the buffer part 115 is formed with a communication hole 1151 for communicating the first flow channel 10 with the third flow channel 21a1. The buffer part 115 can abut against the end face of the jet tube 101A inserted into the mounting groove 114B, restrict the depth of the jet tube 101A inserted into the spray head main body 1, and increase the contact area between the jet tube 101A and the spray head main body 100.

Furthermore, the buffer part 115 may have elasticity, so that when the protruding portion 112 is deformed, even if a tooth contacts the buffer part 115, the vibration of the spray head 100 can be attenuated and transmitted toward the tooth due to the elasticity of buffer part 115.

Since the communicating hole 1151 of the buffer part 115 is located between the first flow channel 10 and the third flow channel 21a1, the problem of blocking hole caused by a tooth directly contacting the communicating hole 1151 can be avoided, and a gathering cavity can be formed on one side of the buffer part 115 and the protruding portion 112 where the water outlet 10b is located, which can serve the function of gathering fluid and prevent the fluid from splashing in the oral cavity.

The buffer part 115 may be in an annular shape surrounding a circumferential direction z of the first flow channel 10, which is not limited herein.

It should be noted that, when the spray head main body 1 comprises the buffer part 115, the protruding portion 112 may be provided with a notch 1123, or may not be provided with a notch 1123. If the protrusion portion 112 is provided with a notch 1123, a bottom wall of the notch 1123 away from the water outlet 1121 may be located at an end of the buffer part 115 close to the water outlet 1121, and a distance is provided between the bottom wall of the notch 1123 away from the water outlet 1121 and the buffer part 115. Alternatively, if the protruding portion 112 is provided with a notch 1123, a bottom wall of the notch 1123 away from the water outlet 1121 may be flush with an end face of the buffer part 115 close to the water outlet 1121.

Referring to FIG. 10, the spray head main body 1 may not be provided with a buffer part 115. In this case, the jet tube 101A extending into the mounting groove 114B may form a gathering cavity together with the side of the protruding portion 112 at which the water outlet 10b is located, which may function to gather the fluid and prevent the fluid from being splashed in the oral cavity.

When the spray head main body 1 is not provided with the buffer part 115, the size of the notch 1123 in the axial direction x of the first flow channel 10 is smaller than the size of the first flow channel 10 in the axial direction x thereof, When the jet tube 101A is mounted in the mounting groove 114B, there is a certain gap between the jet tube 101A and the bottom wall of the notch 1123 away from the water outlet 1121, when the protruding portion 112 is deformed, there is a certain gap between the teeth and the jet tube 101A, and the teeth do not directly contact the jet tube 101A of the rigid material member, the vibration transmitted to the teeth by the nozzle 200 is attenuated.

In some embodiments, the buffer part 115 may be configured as the deformation portion 20 described above in this application.

In some embodiments, as shown in FIGS. 9 and 10, the spray rod 101 is configured as a jet tube 101A, the jet tube 101A has a third inner surface 212 forming the second flow channel 1010 and a third outer surface 213 opposite to the third inner surface 212, the third outer surface 213 comprises a stepped surface 2131, and an end of the spray head 100 away from the water outlet end 1121 abuts against the stepped surface 2131. The stepped surface 2131 can further improve the connection reliability between the jet tube 101A and the spray head 100.

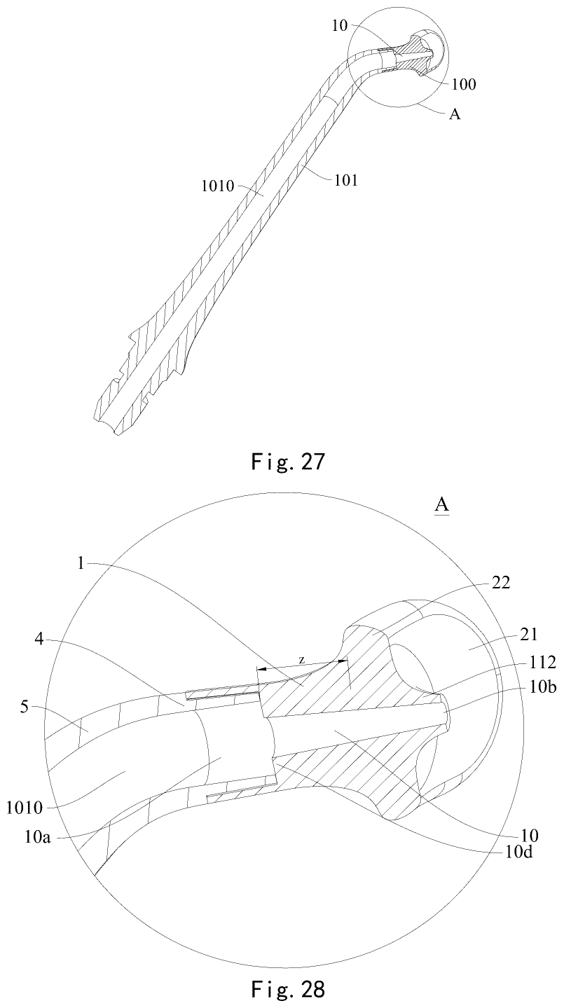

In some embodiments of the present disclosure, as shown in FIGS. 26 and 27, the spray rod 101 comprises a first extension section 3, a second extension section 4 and a transition section 5, wherein the transition section 5 is connected between the first extension section 3 and the second extension section 4, and the first extension section 3 and the second extension section 4 respectively extend along a straight line; the spray head 100 is provided at one end of the second extension section 4 away from the transition section 5, and the spray head main body 1 and the second extension section 4 are coaxially provided, the central axis of the spray head main body 1 coincides with the central axis of the second extending section 4, for example, the central axis of the first flow channel 10 coincides with the central axis of the flow channel in the second extension section 4, the connecting line of the free ends of the two abutting parts 21 is perpendicular to the extending direction of the first extension section 3, and the user can achieve the stable contact between the spray head 100 and the teeth via the spray rod 101, which is suitable for a holding manner in which a user uses the spray head 100 for cleaning, and is suitable for ergonomic design.

In some embodiments of the present disclosure, as shown in FIGS. 26-28, the spray head main body 1 comprises a protruding portion 112, one end of the protruding portion 112 defines a water outlet 10b, and in the extending direction of the first flow channel 10, the protruding portion 112 is located at a side of the stopping structure 2 away from the spray rod 101. A projection of the protruding portion 112 in an extending direction of the first flow channel 10 partially overlaps a projection of the spray rod 101 in an extending direction of the first flow channel 10, and a projection direction of the protruding portion 112 is consistent with a projection direction of the spray rod 101, so that a solid part of the spray rod 101 may provide a certain supporting function for the protruding portion 11.

For example, in the example of FIGS. 26-28, the first flow channel 10 extends in a straight line in the direction in which the first flow channel 10 extends, the projection of the protruding portion 112 partially overlaps with the projection of the spray rod 101, that is, the projection of the solid part of the protruding portion 112 partially overlaps with the projection of the solid part of the spray rod 101, thus, the solid portion of the spray rod 101 may support the protruding portion 112 to ensure that the protruding portion 11 is not easily deformed due to the force, which is good for avoiding hole blocking.

Optionally, in the example of FIG. 28, the cross-sectional area of the protruding portion 112 gradually decreases along the water flow direction towards the direction close to the water outlet 10b, so as to ensure the structural strength of the protruding portion 112 and the connecting strength with other parts of the spray head main body 1, and even if the protruding portion 112 contacts teeth, it is not easy to deform and cause pore blocking.

In some embodiments of the present disclosure, as shown in FIGS. 26-28, the spray head 100 and the spray rod 101 are separate components, and the spray head 100 and the spray rod 101 are separately formed and fixedly connected by means of assembling, for example, the spray head 100 and the spray rod 101 are bonded and fixed, so as to improve the production efficiency of the nozzle 200.

As shown in FIGS. 27 and 28, a peripheral wall of the first flow channel 10 is provided with a limiting step 10d, and one end of the spray head main body 1 away from the water outlet 10b is sleeved at one end of the spray rod 101 in the length direction, one end of the length of the spray rod 101 abuts against the limiting step 10d in the extending direction of the first flow channel 10, the distance between the limiting step 10d and a side surface of the stopping structure 2 facing the spray rod 101 is z, z≤4 mm, so as to ensure that the spray head main body 1 and the spray rod 101 have a suitable length for fitting, and prevent the deformation of the described end of the spray head main body 1 sleeved over the spray head 101 from pore blockage, thus, smooth cleaning is ensured.

For example, z may be 0 mm, or 1 mm, or 2.5 mm, or 3 mm, or 4 mm, etc.

In some examples, the limiting step 10d may be defined by the buffer part 115A or the deformation portion 20 described above in the present disclosure, but it is not limited thereto.

In the example of FIG. 28, one end of the spray head main body 1 away from the water outlet 10b is provided with a sleeve portion, and the sleeve portion is sleeved on the outer side of one end of the length of the spray rod 101, so that one end of the length of the spray rod 101 extends into the sleeve portion, so as to avoid a hole blockage caused by deformation of the sleeve portion. In some examples, the sleeve portion may be formed by the connecting sleeve 40 described above in this application.

Certainly, the present disclosure is not limited thereto. In other embodiments, the spray head 100 and the spray rod 101 may also be integrally formed, for example, the spray head 100 and the spray rod 101 may be integrally injection molded.

An oral irrigator in accordance with a third embodiment of the present disclosure includes a nozzle 200 of an oral irrigator in accordance with the second embodiment of the present disclosure.

According to the oral irrigator of the embodiments of the present disclosure, since the oral irrigator adopt all the technical solutions of all the described embodiments, at least all the beneficial effects brought by the technical solutions of the described embodiments are provided, and no further description will be given here.

For example, the oral irrigator also comprises a machine body (not shown in the FIGure), the machine body comprises a housing, a battery, a water pump assembly and a liquid storage tank which are all disposed in the housing, the battery, the water pump assembly and the liquid storage tank are wrapped by the housing, so that the battery, the water pump assembly and the liquid storage tank can be protected, so as to prolong the service life of the machine body. The material of the housing may be plastic or metal. Exemplarily, the material of the housing may be plastic, so as to reduce the weight of the housing, thereby reducing the weight of the machine body. The battery is connected to the water pump assembly, and is used for supplying power to the water pump assembly. The water pump assembly is in communication with the liquid storage tank and is in communication with the nozzle 200, and is used for pumping the liquid in the liquid storage tank into the nozzle 200, so that the oral cavity of the user can be cleaned. The liquid storage tank is used for storing liquid, the liquid includes, but is not limited to clear water, cleaning liquid, and a mixture liquid of clear water and cleaning liquid.

The nozzle 200 is in communication with the water pump assembly, and is used for guiding the water pumped by the water pump assembly, so as to facilitate cleaning at a position designated by a user. Exemplarily, the nozzle 200 may be detachably connected to the water pump assembly, so as to facilitate replacement of the nozzle 200. Exemplarily, the nozzle 200 may also be integrally formed with the housing and communicate with the water pump assembly. In the embodiment of the present disclosure, a specific form of connection between the nozzle 200 and the housing and the water pump assembly is not limited.

Other constitutions and operations of the oral irrigator according to the embodiments of the present disclosure are known to a person of ordinary skill in the art, and will not be described in detail herein.

In the description of the present disclosure, it should be understood that the orientation or position relations indicated by the terms “center”, “longitudinal”, “lateral”, “length”, “width”, “thickness”, “upper”, “lower”, “front”, “rear”, “left”, “right”, “vertical”, “horizontal”, “top”, “bottom”, “inner”, “outer”, “clockwise”, “counterclockwise”, “axial”, “radial”, “circumferential”, etc. are based on the orientation or position relations shown in the figures, It is only for the convenience of describing the present disclosure and simplifying the description, rather than indicating or implying that the indicated device or element must have a particular orientation, be constructed and operated in a particular orientation. Therefore, it cannot be understood that the present disclosure is limited thereto. In addition, features defined by “first” and “second” may explicitly or implicitly include one or more of this features.

In the description of the present disclosure, unless otherwise specified, “a plurality of” means two or more. “And/or”. Description of association relationship between associated objects indicates that three relationships may exist. For example, A and/or B may indicate three cases: A exists separately, A and B exist simultaneously, and B exists separately. The character “/” generally indicates an “or” relationship between the associated objects.

In the description of the present disclosure, it should be noted that, unless specified or limited otherwise, the terms “mounted,” ‘=’ and “connected” should be understood broadly, and may be, for example, fixed connections, detachable connections, or integral connections; may also be mechanical or electrical connections; may also be direct connections or indirect connections via intervening structures; and may also be inner communications of two elements. The specific meanings of the above terms in the present disclosure can be understood by those skilled in the art according to specific situations.

Reference throughout this description to “an embodiment”, “some embodiments”, “illustrative embodiment”, “example”, “a specific example”, or “some examples” means that a particular feature, structure, material, or characteristic described in connection with the embodiment or example is included in at least one embodiment or example of the present disclosure. Thus, the appearances of the phrases in various places throughout this description are not necessarily referring to the same embodiment or example of the present disclosure. Furthermore, the particular features, structures, materials, or characteristics may be combined in any suitable manner in one or more embodiments or examples.

Although embodiments of the present disclosure have been shown and described, it would be appreciated by those skilled in the art that changes, modifications, alternatives and modifications can be applied to these embodiments without departing from the principle and spirit of the present disclosure, and the scope of the present disclosure is defined by the claims and their equivalents.

What is claimed is:

1. A nozzle for an oral irrigator, comprising a spray head,
the spray head comprising:
a spray head main body defining a first flow channel extending in an axial direction of the spray head main body, one end of the first flow channel being formed as a water inlet, and the other end is formed as a water outlet; and
a stopping structure comprising two abutting portions and two locating portions, wherein the two limiting portions are opposite to each other and disposed along a first direction in a radial direction of the first flow channel, the two locating portions are opposite to each other and disposed along a second direction in the radial direction of the first flow channel, the first direction is perpendicular to the second direction, and the two limiting portions extend from the spray head main body in directions away from each other respectively, such that a first free end of each of the two limiting portions extending from the spray head main body is farther away from the axial direction of the spray head main body than a second free end of each of the two locating portions extending from the spray head main body.

2. The nozzle according to claim 1,
wherein the two limiting portions are soft and elastic, and the limiting portions change a distance between the water outlet and teeth slit of a user by deformation, or the limiting portions are fitted to teeth of a user by deformation.

3. The nozzle according to claim 1,
wherein the spray head main body comprises a protruding portion, at least portion of the first flow channel is formed inside the protruding portion, the protruding portion defines the water outlet on a water outlet direction side, the protruding portion forms at least one notch, and the at least one notch penetrates the protruding portion in the radial direction of the first flow channel so as to allow water from the first flow channel to flow through.

4. A nozzle for an oral irrigator, comprising:
a spray head, the spray head comprising:
a spray head main body, defining a first flow channel extending in an axial direction thereof, one end of the first flow channel being formed as a water inlet, and the other end is formed as a water outlet; and
a stopping structure, comprising two limiting portions opposite to each other and disposed along a first direction in a radial direction of the first flow channel,
the two limiting portions extending from the spray head main body in directions away from each other respectively, each of the two limiting portions having an abutting face which close to the water outlet, and the abutting face bending or tilting towards a water outlet direction as being away from the spray head main body.

5. The nozzle according to claim 4,
wherein the two limiting portions are soft and elastic, and the limiting portions change a distance between the water outlet and teeth slit of a user by deformation, or the limiting portions are fitted to teeth of a user by deformation.

6. The nozzle according to claim 4, wherein
in the radial direction of the first flow channel, a thickness of each of the limiting portions gradually decreases in a direction away from the spray head main body.

7. The nozzle according to claim 4, further comprising a spray rod connected to the spray head main body and being in communication with the water inlet, the spray head is a soft rubber member, the spray rod is a hard tube which is rigid, the hard tube comprises an embedded section which embedded in the spray head main body, and the hardness of the embedded section is greater than the hardness of the spray head main body.

8. The nozzle according to claim 4, wherein outer surfaces of the two limiting portions are in smooth transition connection with an outer surface of the spray head main body.

9. The nozzle according to claim 4,
wherein the stopping structure further comprises two locating portions opposite to each other and disposed along a second direction in a radial direction of the first flow channel, the first direction and the second direction are perpendicular to each other.

10. The nozzle according to claim 9,
wherein a first free end of each of the two limiting portions extending from the spray head main body is farther away from the axial direction of the spray head main body than a second free end of each of the two locating portions extending from the spray head main body.

11. The nozzle according to claim 9,
wherein the two locating portions and the two limiting portions of the stopping structure are connected as a whole and formed as an annular structure, and the annular structure surrounds and connects the spray head main body.

12. The nozzle according to claim 4,
wherein each of the two limiting portions includes a first connecting end connected to the spray head main body and a first free end away from the spray head main body, each of the two limiting portions respectively extends from the first connecting end to the first free end.

13. The nozzle according to claim 12
wherein the abutting face is configured to be at least one of plane and curved surface extending from the first connecting end toward the first free end,
the abutting face is configured to be smooth in at least one direction of a direction extending from the first connecting end to the first free end and a circumferential direction along the first flow channel.

14. The nozzle according to claim 12, wherein
a projection of each of the limiting portion in a first plane is arc-shaped, the first plane is parallel to the axial direction and parallel to an extending direction from the connecting end to the first free end of the first flow channel.

15. The nozzle according to claim 10,
wherein the spray head main body comprises a protruding portion, at least part of the first flow channel is formed inside the protruding portion, the protruding portion defines a water outlet on the side of the water outlet direction.

16. The nozzle according to claim 15,
wherein the protruding portion is provided with at least one notch, and the at least one notch penetrates the protruding portion in the radial direction of the first flow channel so as to allow the water from the first flow channel to flow through.

17. The nozzle for oral irrigator according to claim 15,
wherein one end of the protruding portion close to the water outlet comprises a soft flange used for abutting against teeth.

18. The nozzle for oral irrigator according to claim 15,
wherein the protruding portion does not exceed a joining line of the first free ends of the two limiting portions.

19. The nozzle for oral irrigator according to claim 15, wherein
the protruding portion exceeds a joining line of the first free ends of the two limiting portions.

20. An oral irrigator, comprising a nozzle which comprising a spray head and a spray rod,
wherein the spray head comprises a spray head main body and a stopping structure,
the spray head main body defines a first flow channel extending in an axial direction of the spray head main body, one end of the first flow channel is formed as a water inlet, and the other end is formed as a water outlet; and the stopping structure comprises two limiting portions face to each other and dispose along a second direction in the radial direction of the first flow channel, and the two limiting portions respectively extend from the spray head main body in directions away from each other, and have abutting faces close to the water outlet, and the abutting faces bend or tilt towards a water outlet direction as being away from the spray head main body;
the spray rod defines a second flow channel, and the spray head is provided at one end of the spray rod, such that the water inlet is in communication with the second flow channel.
